(19) United States
(12) Patent Application Publication
(10) Pub. No.: US 2024/0078093 A1
(43) Pub. Date: Mar. 7, 2024

(54) CUSTOMIZABLE AUTOMATED MACHINE LEARNING SYSTEMS AND METHODS

(71) Applicant: DataRobot, Inc., Boston, MA (US)

(72) Inventors: Sylvain Ferrandiz, Perros-Guirec (FR); Zachary Mayer, Cohasset, MA (US); Jason Jay McGhee, Walnut Creek, CA (US); Joshua David Preuss, Newton, MA (US); Mikhail Yakubovskiy, Boston, MA (US)

(73) Assignee: DataRobot, Inc., Boston, MA (US)

(21) Appl. No.: 18/506,380

(22) Filed: Nov. 10, 2023

Related U.S. Application Data
(63) Continuation of application No. PCT/US2022/028565, filed on May 10, 2022.
(60) Provisional application No. 63/186,973, filed on May 11, 2021.

(51) Int. Cl. G06F 8/36; G06F 8/34

(52) U.S. Cl. CPC G06F 8/36; G06F 8/34

(57) ABSTRACT

Customizing an automated machine learning system is provided. The system receives a request to establish computer-executable operations for use with machine learning on a data set. The system provides, for display via a graphical user interface on the client device, an indication of a set of computer-executable operations generated automatically for machine learning on the data set by the system responsive to the request. The system receives, from the client device via the graphical user interface, an indication to modify the set of computer-executable operations. The system establishes compatibility of the set of computer-executable operations responsive to the modification. The system constructs, responsive to establishment of the compatibility, the set of computer-executable operations for use with machine learning.

### CROSS-REFERENCE TO RELATED APPLICATIONS

This application claims the benefit of priority under 35 U.S.C. § 120 as continuation of International Patent Application No. PCT/US2022/028565, filed May 10, 2022, and designating the United States, which claims priority under 35 U.S.C. § 119 to U.S. Provisional Patent Application No. 63/186,973, filed May 11, 2021, each of which is hereby incorporated herein by reference in its entirety for all purposes.

### TECHNICAL FIELD

The present disclosure generally relates to machine learning and data analytics. Portions of the disclosure relate specifically to customizable automated machine learning systems and methods.

### BACKGROUND

Data analytics tools can control systems in a wide variety of fields and industries, e.g., security; transportation; fraud detection; risk assessment and management; supply chain logistics; development and discovery of pharmaceuticals and diagnostic techniques; and energy management. It can be expensive, time-consuming, and error-prone to develop such tools, which can result in unreliable, inaccurate, or faulty operation of such control systems.

### SUMMARY

This technical solution is directed to modifying or customizing automated machine learning systems. For example, an automatically generated blueprint, which can include a set of tasks or computer-executable operations for data pre-processing, data transformations, and predictions, may not seamlessly interface with a particular computing environment or computing scenario. The automatically generated blueprint may, therefore, result in inaccurate data transformation or predictions in the computing environment or computing scenario, resulting in wasted computing resource utilization (e.g., processor or memory utilization) or unreliable or inaccurate operation of a control system.

This technical solution can provide for customization of automatically generated blueprints via a graphical user interface (“GUI”) and a software development kit (“SDK”), as well as the ability to seamlessly switch between the GUI and the SDK. To do so, this technical solution provides the ability to modify one or more tasks or computer-executable operations in an automatically generated blueprint. The technical solution can integrate the customized or modified set of computer-executable operations with the automatically generated blueprint for use in the platform that automatically generated blueprint so as to provide visualization and insights for the modified blueprint. This technical solution can securely integrate the customized task by providing guardrails, validation, and compatibility checks and processes, thereby reducing errors, inaccuracies, faults, while improving reliability and efficiency of computer resource utilization.

Further, the technical solution can receive the customized task from the SDK, while also outputting portion of the automatically generated blueprint for modification via the SDK. The technical solution can then generated additional blueprints based on the modification received from software development kit, thereby allowing the user to seamlessly switch between the GUI and the SDK.

At least one aspect is directed to a system. The system can include a data processing system comprising one or more processors, coupled with memory. The data processing system can receive, from a client device via a network, a request to establish computer-executable operations for use with machine learning on a data set. The data processing system can provide, for display via a graphical user interface on the client device, an indication of a set of computer-executable operations generated automatically for machine learning on the data set by the data processing system responsive to the request. The data processing system can receive, from the client device via the graphical user interface, an indication to modify the set of computer-executable operations. The data processing system can establish compatibility of the set of computer-executable operations responsive to the modification. The data processing system can construct, responsive to establishment of the compatibility, the set of computer-executable operations for use with machine learning.

In some implementations, the data processing system can select a plurality of computer-executable operations that map to an attribute of the data set. The data processing system can present, via the graphical user interface, an indication of the plurality of computer-executable operations. The data processing system can receive, from the client device, an instruction to replace at least one of the plurality of computer-executable operations with at least one of a computer-executable operation at least partially coded by a user via a software development kit or selected by the user via a catalog of computer-executable operations.

The data processing system can receive, from the client device, an indication to add a custom computer-executable operation in the set of computer-executable operations. The custom computer-executable operation can include code generated by a user via a software development kit and uploaded to the data processing system. The data processing system can determine the custom computer-executable operation is incompatible with the set of computer-executable operations. The data processing system can modify, responsive to the determination of incompatibility, a computer-executable operation of the set of computer-executable operations. The data processing system can construct, responsive to the modification, the set of computer-executable operations with the custom computer-executable operation.

The data processing system can establish the compatibility of the set of computer-executable operations based on a comparison of an attribute of an output value of a first computer-executable operation of the set of computer-executable operations with an attribute of an input value of a second computer-executable operation. The attribute can correspond to at least one of a data type, a data sparsity, a binary representation of data, a shape of data, or missing values.

The data processing system can automatically modify a computer-executable operation of the set of computer-executable operations to establish the compatibility. The data processing system can provide a prompt via the graphical user interface indicating the automatic modification.

The data processing system can execute the constructed set of computer-executable operations to generate a model based on the data set via machine learning. The data processing system can deploy the model to make predictions based on an input data stream different from the data set.

In some cases, prior to the modification, the set of computer-executable operations automatically generated by the data processing system can lack a configuration to extract a feature from input data. Subsequent to the modification and establishment of the compatibility. the set of computer-executable operations can be configured to extract the feature from the input data.

The data processing system can provide, upon execution of the constructed set of computer-executable operations, via the graphical user interface, a first visual representation of data generated subsequent to execution of a first computer-executable operation of the set of computer-executable operations. The data processing system can provide, via the graphical user interface, a second visual representation of data generated subsequent to execution of a second computer-executable operation of the set of computer-executable operations.

The data processing system can present, via the graphical user interface, the set of computer-executable operations as a directed acyclic graph. The set of computer-executable operations can include at least one of a data transform or a prediction.

The data processing system can share at least a portion of the set of computer-executable operations with a second client device for inclusion in a second set of computer-executable operations established via the second client device.

At least one aspect is directed to a method. The method can be performed by a data processing system including one or more processors coupled with memory. The method can include the data processing system receiving, from a client device via a network, a request to establish computer-executable operations for use with machine learning on a data set. The method can include the data processing system providing, for display via a graphical user interface on the client device, an indication of a set of computer-executable operations generated automatically for machine learning on the data set by the data processing system responsive to the request. The method can include the data processing system receiving, from the client device via the graphical user interface, an indication to modify the set of computer-executable operations. The method can include the data processing system establishing compatibility of each computer-executable operation of the set of computer-executable operations responsive to the modification. The method can include the data processing system constructing, responsive to establishment of the compatibility, the set of computer-executable operations for use with machine learning.

In some implementations, the method can include the data processing system selecting a plurality of computer-executable operations that map to an attribute of the data set. The method can include the data processing system presenting, via the graphical user interface, an indication of the plurality of computer-executable operations. The method can include the data processing system receiving, from the client device, an instruction to replace at least one of the plurality of computer-executable operations with a computer-executable operation at least partially coded by a user.

The method can include the data processing system receiving, from the client device, an indication to add a custom computer-executable operation in the set of computer-executable operations, the custom computer-executable operation comprising code generated by a user and uploaded to the data processing system. The method can include the data processing system determining the custom computer-executable operation is incompatible with the set of computer-executable operations. The method can include the data processing system modifying, responsive to the determination of incompatibility, a computer-executable operation of the set of computer-executable operations. The method can include the data processing system constructing, responsive to the modification, the set of computer-executable operations with the custom computer-executable operation.

The method can include the data processing system establishing the compatibility of the set of computer-executable operations based on: i) a comparison of an attribute of an output value of a first computer-executable operation of the set of computer-executable operations with an attribute of an input value of a second computer-executable operation. The attribute can correspond to at least one of a data type, a data dimensionality, a binary representation of data, or shape of data.

An aspect of this disclosure can be directed to a system. The system can include a data processing system comprising one or more processors, coupled with memory. The data processing system can receive, from a client device via a network, a request to establish a blueprint comprising a plurality of tasks for use with machine learning. The data processing system can generate, automatically by the data processing system, the blueprint with the plurality of tasks. The data processing system can provide, for display via a graphical user interface on the client device, an indication of the plurality of tasks of the blueprint automatically generated by the data processing system responsive to the request from the client device. The data processing system can receive, from the client device via the graphical user interface, a modification to the blueprint. The data processing system can establish compatibility of each task of the blueprint responsive to the modification. The data processing system can construct, responsive to establishment of the compatibility, the blueprint for use with machine learning.

The data processing system can receive the modification comprising at least one of a custom task generated via a software development kit, or a modification to a task of the plurality of tasks automatically generated by the data processing system for the blueprint. The data processing system can generate, via the software development kit, a plurality of blueprints based at least in part on the modification. The data processing system can present a visualization for the plurality of blueprints via the graphical user interface.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 depicts a block diagram of an example system for a customizable automated machine learning system.

FIG. 2 depicts a block diagram of an example method for customizing an automated machine learning system.

FIG. 3 depicts a block diagram of an example method for customizing an automated machine learning system.

FIG. 4 depicts a block diagram of an example method for customizing an automated machine learning system.

FIGS. 5-24 are example graphical user interfaces that facilitate customizing an automated machine learning system.

FIG. 25 is an example computer system that can be used in implementing technology described herein, including, for example, the system depicted in FIG. 1, the methods depicted in FIGS. 2-4, and the graphical user interfaces depicted in FIGS. 5-24.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations.

Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Data analytics tools can be used to guide control systems in a wide variety of fields and industries, e.g., security; transportation; fraud detection; risk assessment and management; supply chain logistics; development and discovery of pharmaceuticals and diagnostic techniques; and energy management. Developing data analytics tools for carrying out specific data analytics tasks can be computationally resource intensive, expensive, error-prone, and time-consuming. Such processes can include steps of data collection, data preparation, feature engineering, model generation, and/or model deployment.

“Automated machine learning” technology may be used to automate significant portions of the above-described process of developing data analytics tools. Automated machine learning technology can lower the barriers to the development of certain types of data analytics tools, particularly those that operate on time-series data, structured and unstructured textual data, categorical data, and numerical data.

In some cases, user customization of (e.g., intervention into) the operation of an automated machine learning platform may facilitate development of modeling blueprints (e.g., “blueprints,” “modeling pipelines,” or “pipelines”) having desired characteristics. For example, a user (e.g., an organization) may be subject to specific regulatory requirements that disallow the use of specific transformations or modeling techniques that may be integrated into blueprints generated by an automated ML platform. In such cases, the user may prefer to configure the platform to prohibit use of such transformations and/or modeling techniques during the development of specific blueprints, or to replace such transformations and/or modeling techniques with non-prohibited alternatives in existing blueprints. As another example, a user's input data may be represented in formats that are not directly compatible with (e.g., interpretable or ingestible by) conventional automated machine learning tools. In such cases, the user may choose not to use the incompatible data, which can adversely affect the performance of any blueprint developed without the incompatible data. Alternatively, the user may choose to transform the incompatible data into a compatible form prior to providing the data to the platform. However, when performing such feature transformations outside the automated ML platform, the user does not benefit from the platform's ability to tune the feature transformation process and, therefore, may choose sub-optimal transformations that adversely affect the performance of any blueprint developed with the transformed data.

As yet another example, a user may wish to incorporate its domain expertise or existing (e.g., proprietary) modeling techniques into the platform's workflow for the development of blueprints. Likewise, a user may wish to validate the performance of a generated blueprint by testing similar or alternative blueprints and observing the blueprints' relative performance in an identical environment, with minimal effort.

This technical solution can allow for customization of automated machine learning tools modifying the automated blueprint-development process. This technical solution can provide customization via a graphical user interface (“GUI”) or a software development kit (“SDK”), or both. This technical solution can support integration of automated ML tools (e.g., the application of automated ML techniques to adjust (e.g., optimize) with parameters of user-provided and/or customized modules). Thus, this technical solution can provide support for collaboration, including between users whose custom modeling techniques are coded in different programming languages.

Systems and methods of this technical solution provide customizable automated machine learning systems and methods. In some embodiments, a customizable automated ML system provides tools for (1) customizing pre-existing machine learning blueprints and/or components thereof (e.g., models and tasks), (2) integrating built-in and custom modules with no constraints on dependencies, (3) sharing of custom blueprints across an organization, and/or (4) customizing the automated machine learning process itself alongside custom-built modules. In some embodiments, the various functions and capabilities of an automated ML system (e.g., automated data preparation, insights, deployment, and monitoring) can be integrated with and/or applied to blueprints that integrate custom modules.

In some embodiments, robust guardrails are provided to simplify the construction, customization, and/or tuning of blueprints incorporating custom modules. Such guardrails may include syntactic checks (e.g., automatic application of rules to confirm that the data types of inputs provided to blueprint modules are compatible with those modules). Some embodiments may support the integration of customization and automation (e.g., the application of automated ML techniques to adjust (e.g., optimize) the parameters of user-provided and/or customized modules). In some embodiments, the customizable automated ML system may use meta machine-learning techniques to observe the combinations of tasks in blueprints (customized or built-in) and the efficacy of those combinations, and learn from those observations in order to adapt and improve the system's performance.

Some non-limiting embodiments of a customizable automated machine learning techniques are described herein. Systems incorporating these techniques may provide simple, reusable, flexible, collaborative, and customizable platforms for the development of blueprints by users of any level of expertise (e.g., by programmers and/or non-programmers).

### Terms

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a data set), diagnostic analytics (e.g., processes for inferring why specific trends, patterns, anomalies, etc. are present in a data set), predictive analytics (e.g., processes for predicting future events or outcomes), and prescriptive analytics (processes for determining or suggesting a course of action).

“Machine learning” generally refers to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

A feature of a data sample may be a measurable property of an entity (e.g., person, thing, event, activity, etc.) represented by or associated with the data sample. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have a numerical data type, a categorical data type, a time-series data type, a text data type (e.g., a structured text data type or an unstructured (“free”) text data type), an image data type, a spatial data type, or any other suitable data type. In general, a feature's data type is categorical if the set of values that can be assigned to the feature is finite.

As used herein, “time-series data” may refer to data collected at different points in time. For example, in a time-series data set, each data sample may include the values of one or more variables sampled at a particular time. In some embodiments, the times corresponding to the data samples are stored within the data samples (e.g., as variable values) or stored as metadata associated with the data set. In some embodiments, the data samples within a time-series data set are ordered chronologically. In some embodiments, the time intervals between successive data samples in a chronologically-ordered time-series data set are substantially uniform.

Time-series data may be useful for tracking and inferring changes in the data set over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

As used herein, “image data” may refer to a sequence of digital images (e.g., video), a set of digital images, a single digital image, and/or one or more portions of any of the foregoing. A digital image may include an organized set of picture elements (“pixels”). Digital images may be stored in computer-readable file. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.).

As used herein, “non-image data” may refer to any type of data other than image data, including but not limited to structured textual data, unstructured textual data, categorical data, and/or numerical data. As used herein, “natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” may refer to audio signals representing sound and/or data derived therefrom.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training data set. The terms “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a machine learning algorithm and a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

As used herein, a “modeling blueprint” (or “blueprint”) refers to a computer-executable set of preprocessing operations, model-building operations, and postprocessing operations to be performed to develop a model based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features.

As used herein, “automated machine learning platform” (e.g., “automated ML platform” or “AutoML platform”) may refer to a computer system or network of computer systems, including the user interface, processor(s), memory device(s), components, modules, etc. that provide access to or implement automated machine learning techniques.

Techniques for Customizing Blueprints for an Automated Machine Learning Platform

An exemplary method for customizing a blueprint for an automated machine learning platform can include one or more of the following steps. In a first step, an automatically generated blueprint can be cloned to create a customizable blueprint. Alternatively, a user can start developing a customizable blueprint from scratch. In a second step, a user can customize the blueprint via a user interface of the platform (e.g., without writing new code). Alternatively, the user can programmatically modify the blueprint (e.g., using Python or any other suitable programming tool). For example, the user can build custom modules (e.g., “tasks”) that incorporate user-provided code. These modules may provide a simple interface between the platform and the user's code. For example, the module interface may specify the data types of the inputs to the user's code, the data types and permissible ranges of values for one or more parameters (e.g., modeling parameters) of the user's code, etc. After customizing the blueprint, the user may share the customized blueprint and/or any custom modules with other users (e.g., other users within the user's organization); use the customized blueprint to train one or more models; view platform-generated insights about the blueprint and/or the model(s) trained therewith; and/or deploy the blueprint.

In a specific example, the customizable machine learning platform can allow a user to clone a blueprint, build on the blueprint or use the blueprint to train a model on a data set, and output the blueprint's source code. Subsequently, the same user or a different user can edit the blueprint's source code, display the modified blueprint, and run the modified blueprint. Some non-limiting embodiments of techniques for customizing blueprints for automated machine learning platforms are described herein. See, e.g., Appendix A at pp. A4 and A13-A16.

User Interfaces for a Customizable Machine Learning Platform

A customizable machine learning platform may provide one or more user interfaces (UIs) through which users can interact with the platform to customize blueprints. For example, the platform may provide a graphical UI and/or a programmatic UI.

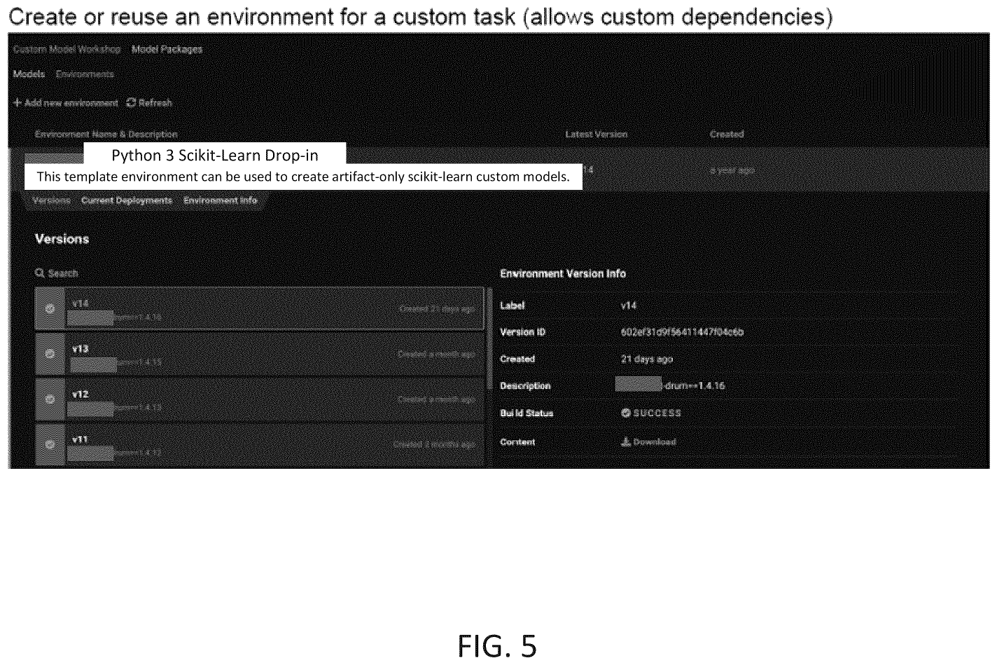

In some embodiments, a graphical UI (or graphical components of a platform's UI) may permit a user to customize blueprints (e.g., by adding, swapping, and/or removing machine learning tasks, modules, and/or edges from blueprints) using familiar GUI components and techniques (e.g., point-and-click, drag-and-drop, etc.), without engaging in traditional “computer programming” activities (e.g., writing or editing source code or scripts). Some embodiments of a graphical UI for customizing blueprints are depicted in FIGS. 5-15.

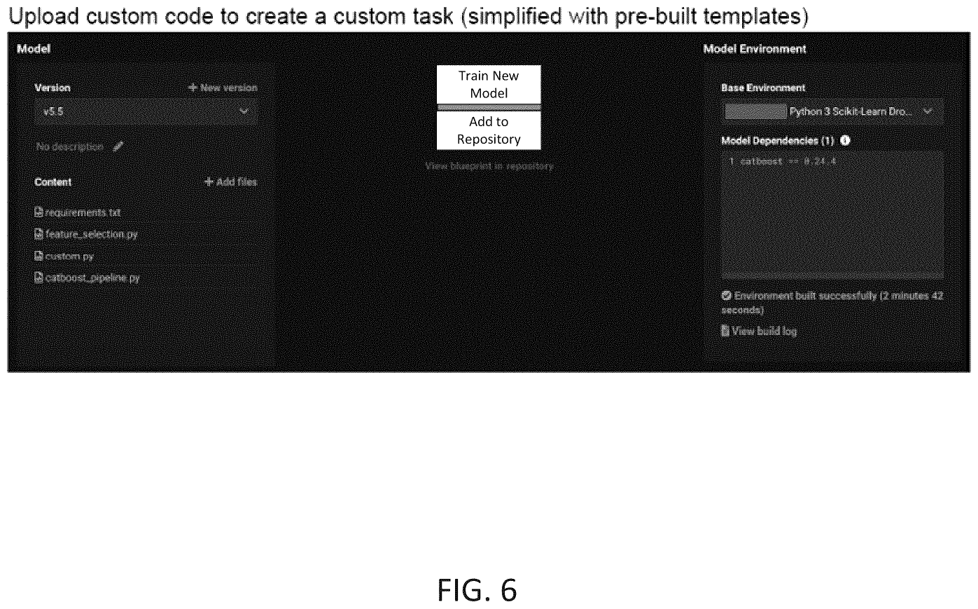

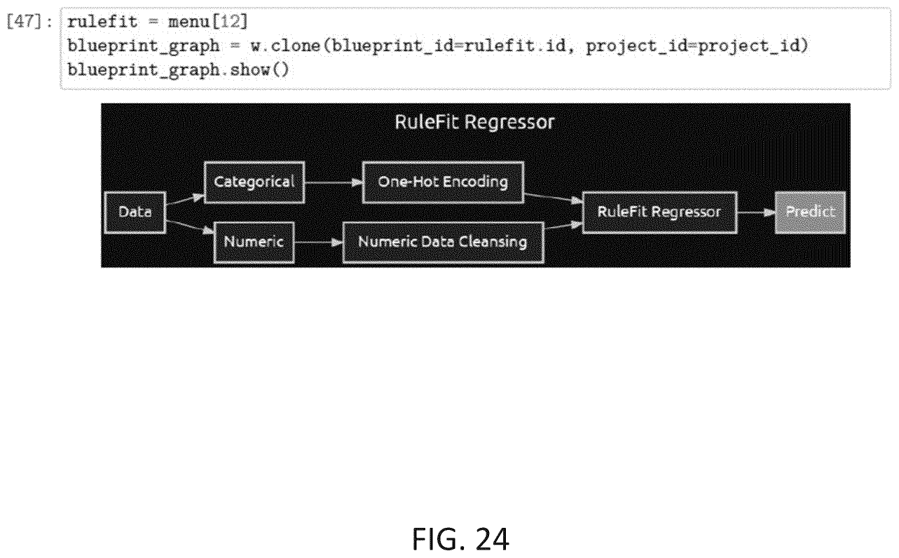

In some embodiments, a programmatic UI (or programmatic aspects of a platform's UI) may permit a user to customize blueprints using user-generated code (e.g., source code, scripts, etc.). For example, through the programmatic UI, users can add, swap, and/or remove machine learning tasks, modules, and/or edges from blueprints. Performing such operations through the programmatic UI allows users to perform the operations rapidly and/or in bulk. In some embodiments, a user may train a model to build (and/or customize) blueprints by generating (and/or modifying) the blueprint's programmatic representation (code). In another example, through the programmatic UI, users can write their own scripts or develop their own pre-processing modules and/or tasks. In some examples, the customizable machine learning platform can be programing language agnostic, in the sense that the platform may allow users to integrate custom modules or scripts written in any suitable programming language into blueprints, rather than requiring users to port their code to a common language. In some examples, users can code their custom modules in Python, R, among other programming languages. In some examples, the customizable machine learning platform can allow users to integrate custom binaries (e.g., executable software modules) into blueprints, rather than requiring users to regenerate their binaries using prescribed libraries and/or dependencies. Some embodiments of a programmatic UI for customizing blueprints are depicted in FIG. 6 and FIG. 24.

In some embodiments, the platform may facilitate integration of customized modules into blueprints by defining a common schema for both customized and built-in modules. The module schema may specify attributes of the model's inputs (e.g., number of inputs, data types of inputs, etc.), attributes of the model's outputs (e.g., number of outputs, data types of outputs, etc.), and/or attributes of the model's parameters (e.g., hyperparameters) (e.g., number of parameters, data types of parameters, ranges of permissible values for each parameter, etc.). The use of such a schema may facilitate the platform's application of guardrails (see below) and parameter optimization techniques to customized blueprints.

Some embodiments of the platform's UI may enable the platform to provide functionality that is generally not offered by conventional automated machine learning platforms. In an example, users can integrate their own models into blueprints as custom modules. In some embodiments, the customizable machine learning platform can receive data/output from the user's custom module/task and use that data as input for one or more other modules/tasks (e.g., customer or built-in modules/tasks) within a blueprint. In a specific example, the customizable machine learning platform can enable a user to integrate a module that implements a custom embedding (e.g., feature extraction operation) for a data type of interest (e.g., a data type not directly compatible with the platform or with a module in the user's blueprint). In some embodiments, integration of modules that generate embeddings can enable the platform to optimize parameters of the embedding task.

Guardrails for Blueprint Customization

When users customize blueprints, they may introduce errors that can cause the blueprints to malfunction (e.g., terminate prematurely, crash a computer system on which the blueprint is running, etc.) or perform poorly (e.g., not process data in the manner the user intended or expected). In some embodiments, a platform may provide “guardrails” to detect and/or mitigate such errors. Some non-limiting examples of mitigation may include notifying the user of the detected error, suggesting a modification that would correct the detected error, automatically modifying the blueprint to remove or compensate for the error, etc. In some embodiments, the platform may display such a notification and/or suggestion in response to a user clicking on a module or hovering the pointer over the module. Some non-limiting embodiments of guardrails are described below.

In some embodiments, the platform's interface may display the attributes of the inputs and/or outputs of one or more (e.g., all) modules of a blueprint. The platform may determine or derive the attributes of a module's inputs and/or outputs based on the module's schema. In some embodiments, the platform may validate all dataflow connections between modules in a blueprint. When a first module generates output data and provides that output data as an input to a second module, such validation may involve determining whether the specified attributes of the first module's output data match (or are compatible with) the specified attributes of the second module's input data. In some embodiments, the attributes of dataflow connections validated by the platform may include the data's type, the data's dimensionality, the data's binary representation (e.g., sparse or dense), the data's shape, whether the data have missing values, etc. Some non-limiting embodiments of guardrails for blueprint customization (e.g., modification and/or construction) are described herein.

Additional Aspects

Additional aspects of a customizable automated machine learning platform are described herein. In some embodiments, a platform can provide a step-by-step visualization of how the user's data changes as each of a blueprint's tasks (e.g., transformation task or modelling task) is applied to the data. Such visualizations can clearly indicate the impact of each task on the data. For example, such visualizations show how effective a standardization task is, or how well a clustering task clusters the data, etc.

In some embodiments, a platform may provide auto-complete functionality during blueprint construction. In an example, the platform may automatically suggest suitable tasks to use in combination with the tasks already present in the blueprint. Alternatively, the platform may provide functionality whereby the user can request or specify automatic substitution of one or more tasks at training time, such that the platform may use AutoML techniques to automatically decide which tasks to leverage based on, for example, the project data and target. In some examples, the automatic substitution capability of a blueprint can be represented in the UI. For example, instead of showing a model such as “XGBoost” in the editor, a DataRobot logo can be presented and/or another special (e.g., wildcard) symbol can be presented, which can represent that automatic substitution will be performed at training time. Such data-driven modification of a model-development blueprint at training time greatly enhances the blueprint's flexibility.

In some embodiments, the platform may permit the user to specify a custom metric for measuring the performance of a blueprint and comparing the performance of a set of blueprints.

Some non-limiting examples of additional aspects of a customizable automated machine learning platform are described herein.

Visualization of Programmatically-Developed Blueprints

As described above, some embodiments of the platform may provide a programmatic user interface for customizing (e.g., developing) blueprints. When a blueprint is developed in a programmatic UI, the platform may provide a visualization of the connections between and/or attributes of the blueprint's modules (e.g., tasks). In an example, the platform can provide a visual representation of a programmatically-developed blueprint in real-time while the user is coding the blueprint. In some embodiments, the platform can provide (e.g., simultaneously provide) a user with both a view of the blueprint's code and a view, e.g., a visual block diagram, of the blueprint's modules. Additionally, the platform may provide visualizations of validation operations and/or other guardrails in the programmatic UI. Some non-limiting embodiments of techniques for providing blueprint visualizations are described herein.

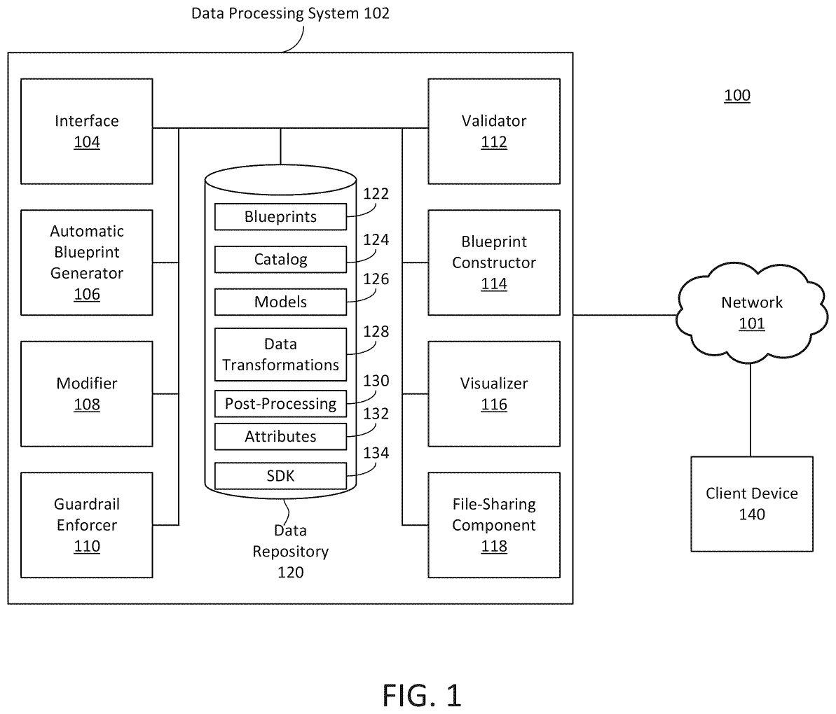

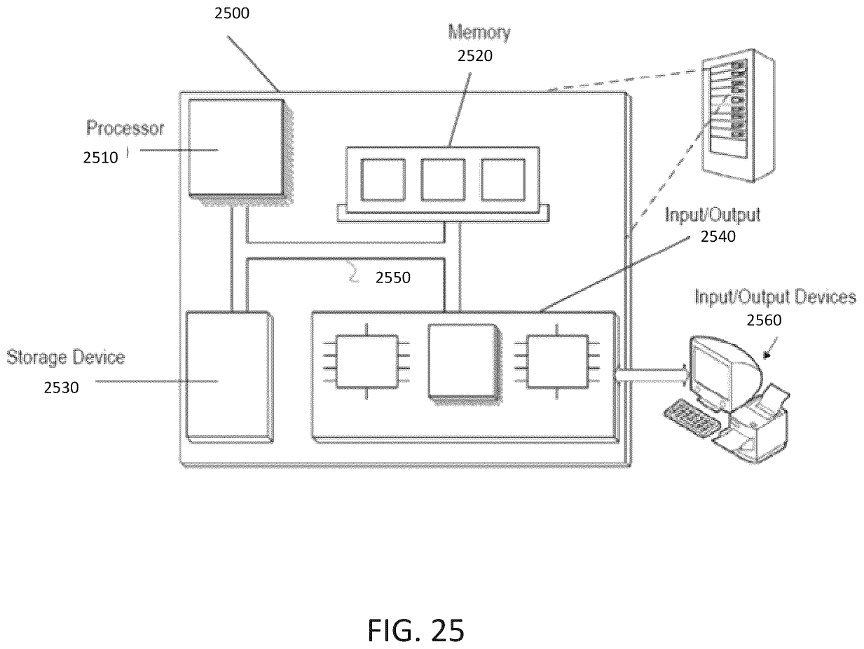

Referring now to FIG. 1, a block diagram of an example system for customizing an automated machine learning system is provided. The system 100 can include a data processing system 102 that can communicate, interface with, or otherwise exchange data or information with a client device 140 via a network 101. The data processing system 102 can include one or more components or memory. The data processing system 102 can include one or more processors or memory. The data processing system 102 can include one or more processors communicatively or electronically coupled with memory. The client device 140 can include one or more processors or memory. The client device 140 can include one or more processors communicatively or electronically coupled with memory. The data processing system 102 can include one or more component, system, hardware, or functionality of system 2500 depicted in FIG. 25. The client device 140 can include one or more component, system, hardware, or functionality of system 2500 depicted in FIG. 25.

The data processing system 102 can include, be configured, or interface with a cloud computing system. The data processing system 102 can include, execute on, or be hosted on one or more servers. The data processing system 102 can execute on, be hosted on, or otherwise be provided via a cloud computing environment hosted by one or more data centers.

The data processing system 102 can include an interface 104 designed, constructed and operational to communicate with client device 140 via network 101. The interface 104 can include any type of hardware or software interface. The interface 104 can include a network interface. The interfaced 104 can include or provide a user interface via the client device 140. For example, the interface 104 can provide one or more graphical user interface for display or render via client device 140. The interface 104 can facilitate communications between one or more components of the data processing system 102.

The data processing system 102 can include an automatic blueprint generator 106 designed, constructed, and operational to automatically generate a blueprint 122. A blueprint can refer to or include one or more computer-executable operations. The computer-executable operations can include, for example, data cleaning processes, data transformations, or machine learning modeling techniques. Machine learning modeling technique scan include the development of machine learning models or the deployment of machine learning. A deployed machine learning model can be used to make predictions based on input that has not previously been used to train the model using machine learning.

The automated blueprint generator 106 can include or be configured with an automated machine learning platform (e.g., “automated ML platform” or “AutoML platform”) that can provide access to or implement automated machine learning techniques. The automated blue print generator 106 can generate a blueprint, which can refer to a computer-executable set of preprocessing operations, model-building operations, and postprocessing operations to be performed to develop a model based on the input data. The data processing system 102 can receive, from a client device 140 via a network 101, a request to establish the blueprint 122 (e.g., computer-executable operations) for use with machine learning on a data set. The data processing system 102 can generate the blueprints 122 “on-the-fly” (e.g., real-time, responsive to a request, just-in-time, within 1 second of a request, within 2 seconds of a request, within 5 seconds of a request, within 15 seconds of a request, or otherwise responsive to a request) based on any suitable information including, without limitation, the size of the user data, features types, feature distributions, etc. The data processing system 102 can generate blueprints capable of jointly using multiple (e.g., all) data types, thereby allowing the model to learn the associations between image features, as well as between image and non-image features.

To do so, the automatic blueprint generator 106 can run several different versions of various algorithms and test thousands of possible combinations of data preprocessing and parameter settings. The data processing system 102 can generate a blueprint 122 that includes preprocessing steps, modeling algorithms, and post-processing steps that are automatically generated and combined.

The blueprint 122 can include data transformations 128, which can refer to tasks that perform transformations on data. Data can refer to any incoming data, separated into each type (e.g., categorical, numeric, text, image, or geospatial). Blueprints 122 can include or be constructed to perform different types of data transformations 128 on different datasets. For example, different columns in a dataset can be transformed with different types of preparation. For example, a data transformation 128 can recommend subtracting the mean and dividing by the standard deviation of the input data in order to impute missing values. However, this transformation 128 may not apply or produce errors for text input data. Thus, a step (e.g., a first step or initial step) in a blueprint can be to identify the data types that belong together so that they can be processed separately.

A blueprint 122 can include a models 126. Models 126 can be trained using machine learning to make predictions or supply stacked predictions to a subsequent model 126.

A blueprint 122 can include one or more post-processing 130 steps. Post-processing can refer to steps taking after one or more steps, such as after data transformations or model outputs, for example. Post-processing 130 steps can include, for example, calibration. The blueprint 122 can include a prediction step, which can refer to or include the data being sent out of the blueprint 122 as the final prediction.

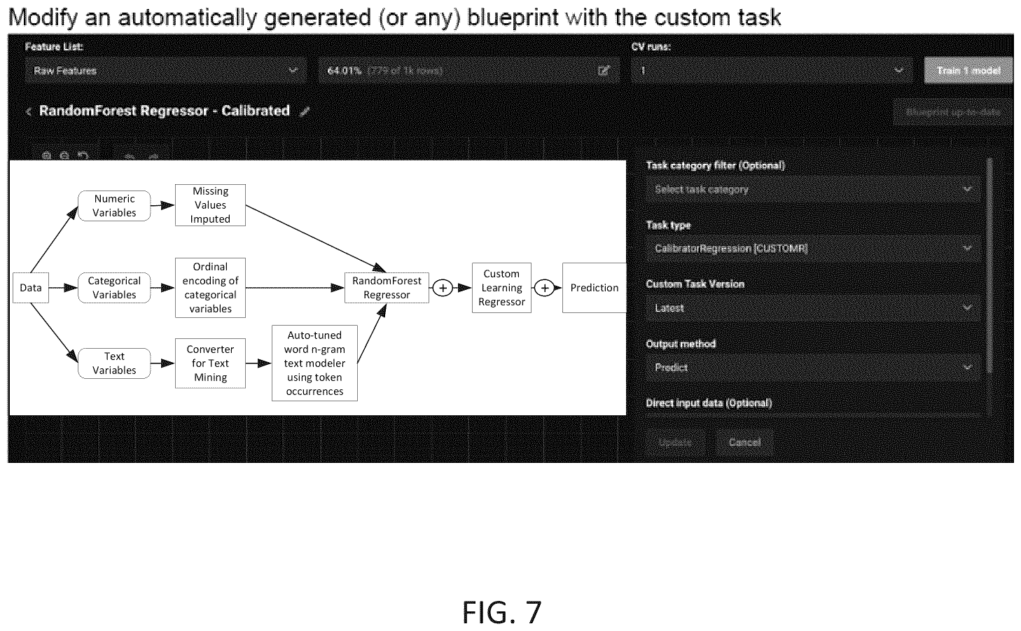

A blueprint 122 can include nodes and edges (e.g., connections). A node can take in data, perform an operation, and output the data in its new form. An edge can be a representation of the flow of data. When two edges are received by a single node (e.g., as depicted in FIG. 7), it can be a representation of two sets of columns being received by the node. The two sets of columns can be stacked horizontally, for example. that is, the column count of the incoming data can be the sum of the two sets of columns and the row counts can remain the same, for example.

If two edges are output by a single node, it can be a representation of two copies of the output data being sent to other nodes, where the other nodes in the blueprint 122 can be other types of data transformations or models.

Thus, the automated blueprint generator 106 can access a repository of blueprints 122 or automatically generate a blueprint 122 responsive to a request. The automated blueprint generator 106 can provide multiple blueprints 122 responsive to request received from a client device 140. A user of the client device 140 can input a request via user interface or graphical user interface of the client device 140. The request can be to automatically generate a blueprint 122 for a data set. Responsive to the request, the automatic blueprint generator 106 can try numerous (e.g., 10s, 100s, or more) diverse modeling approaches on an input data set provided by the user or otherwise selected by the user. The automatic blueprint generator 106 can suggest the top ranking blueprints 122 to the user for selection. The top ranking blueprints 122 can be those that satisfy a performance metric, such as do not raise any errors or faults, have satisfactory predictions, can execute within a time threshold, or otherwise performance indicators.

To automatically generate or select a blueprint 122 for an input data set, the data processing system 102 can choose an appropriate metric to gauge performance of a generated blueprint 122, for example. The data processing system 102 can attempt a number of different techniques, such as training blueprints, incorporating an XGBoost model, a neural network, a state vector machine (“SVM”), or an Elastic-Net. The data processing system 102 can attempt a number of different configurations via searching hyperparameters and preprocessing for each configuration. The data processing system can perform feature selection and then select ensembles. The data processing system 102 can construct the blueprint 122 as directed graph of tasks (e.g., computer-executable operations) which receive data and transform the data or produce predictions about the data, which can produce predictions based on a specified target. The direct graph can refer to a graph that flows or in which data flows in one direction, such as from left to right. The directed graph can be an acyclic graph such that the data flows from an input beginning to an output end, but does not cycle back on itself or create a loop.

Thus, the data processing system 102 can provide, for display via a graphical user interface on the client device 140, an indication of a set of computer-executable operations (e.g., one or more blueprints 122) generated automatically for machine learning on the data set by the data processing system 102 responsive to the request.

However, in some cases, the blueprint 122 automatically generated by the data processing system 102 may not contain certain tasks, transformation, modelling techniques, or post-processing techniques that satisfy a technical problem or is compatible with a computing environment of the client device 140 or user thereof. For example, the client device 140 may contain an input or output function or operation for which the blueprint 122 is not compatible, which can result in error, faults, inaccurate results, or unnecessary, inefficient, or redundant processing that can introduce latencies into the system.

Thus, systems and methods of this technical solution can provide a modifier 108 designed, constructed and operational to allow for modification, customization or otherwise improving of the blueprint 122 automatically generated by the automatic blueprint generator 106. The modifier 108 can receive instructions to modify via a GUI, such as via a drag-and-drop functionality, button clicks, selections, or other interactive GUI elements. The data processing system 102 (e.g., modifier 108 via interface 104) can receive, from the client device 140 via the graphical user interface, an indication to modify the set of computer-executable operations. Example GUIs for modifying or customizing aspects of the blueprint 122 are depicted in FIGS. 5-24.

For example, the data processing system 102 can receive instructions to modify the blueprint via a GUI or an SDK, or both. In some cases, the blueprint can be entirely modified via a GUI interface. In some cases, the blueprint 122 can be modified via an SDK in which a user can provide code or a script that can modify a parameter of a node in a blueprint 122, for example. In some cases, the data processing system 102 can receive instructions to modify the blueprint 122 both via code from an SDK as well as interactions via a GUI, thereby allowing for the seamless switching between SDK and GUI-based modifications of an automatically generated blueprint 122.

For example, a user of client device 140 can select a plurality of computer-executable operations that map to an attribute of the data set. Attributes of a data set can include, for example, a type of data (e.g., categorical, numerical, text, or geospatial), data sparsity, binary representation of data, a shape of data, or missing values. Sparse data, or data sparsity, can refer to a sparse matrix of numbers that includes many zeros or values that will not significantly impact a computation. A dense matrix can refer to a matrix where each entry has a value. Different types of data transformations can be compatible or can efficiently process data based on sparsity. A binary representation of data can refer to data having values of 0 or 1. A shape of data can refer to a distribution or pattern of data within a data set. For example, a shape of data can be determined based on a histogram of values in the data set, and can represent data sets that are symmetric, skewed left, or skewed right, for example. Missing values can refer to the number of values in the data set that are missing or have null values. Depending on the number of missing values and the type of data (e.g., numerical) a data transformation or pre-processing step can be to impute the missing values.

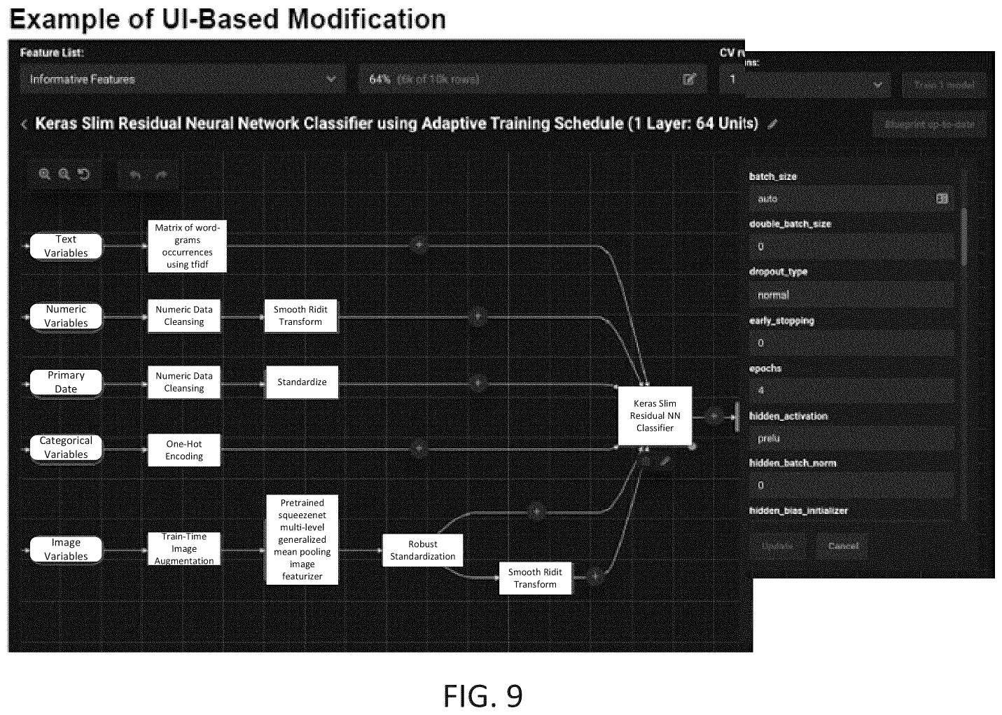

The data processing system 102 can present, via the graphical user interface, an indication of the blueprints 122 (e.g., computer-executable operations) that were automatically generated by the data processing system 102. The data processing system 102 can receive, from the client device 140, an instruction to replace at least one of the computer-executable operations with at least one of a computer-executable operation at least partially coded by a user via a software development kit or selected by the user via a catalog 124 of computer-executable operations. The catalog 124 of tasks can refer to a variety of tasks through which a user can search for a task to include in a blueprint 122. The data processing system 102 can allow a user to modify the blueprint 122 via a GUI, as indicated in FIGS. 9-16, for example.

For example, the data processing system 102 can provide a catalog of tasks or computer-executable operations for preprocessing steps, data transformations, models, or post-processing steps from which a user can select a new task or computer-executable operation. The data processing system 102 can present the catalog of tasks via a GUI. In some cases, the data processing system 102 can filter the catalog to provide a list of a subset of tasks from which the use can select a task to replace a task in the automatically generated blueprint 122. In some cases, the data processing system 102 can provide a full list of tasks from which the user can select a task. In some cases, the data processing system 102 can provide a search or filter function with which the user can search for a task, search for a type of task, or filter or rank or sort the list of tasks in the catalog.

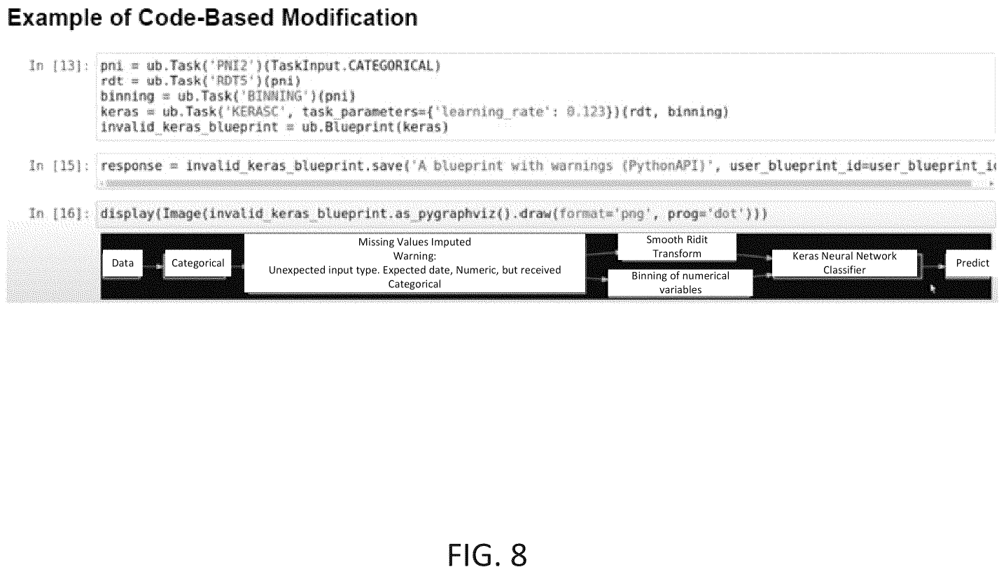

In some cases, the data processing system 102 can receive an indication to modify the automatically generated blueprint 122 via a custom generated code, and example of which is depicted in FIG. 8. The code can be generated or prepared by a user via an SDK. For example, the data processing system 102 can receive, from the client device 140, an indication to add a custom computer-executable operation in the set of computer-executable operations. The custom computer-executable operation can include code generated by a user via a software development kit and uploaded to the data processing system 102. The data processing system 102 can then perform guardrail enforcement, validation or compatibility on the custom code prior to constructing the modified blueprint.

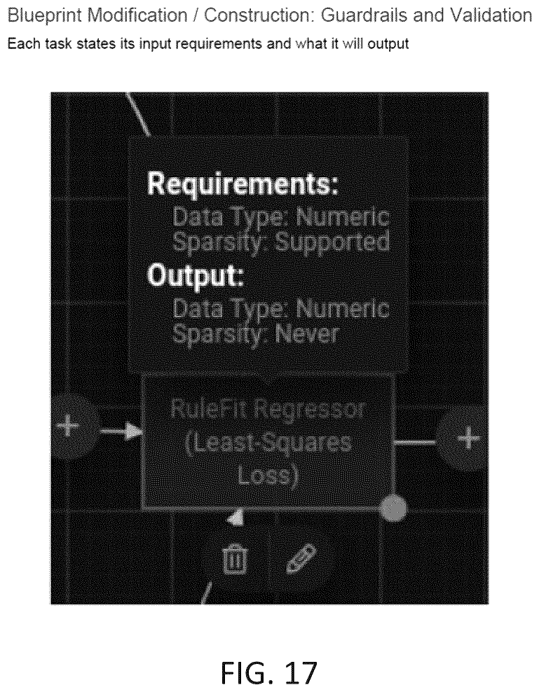

The data processing system 102 can include a guardrail enforcer 110 designed, constructed and operational to enforce constraints or guardrails so as to reduce errors, faults, or inefficiencies that can result from incorrect modification of a blueprint 122 by a user. The guardrail enforcer can prevent modifications that may be incompatible with the automatically generated blueprint 122. The guardrail enforcer 110 can receive an indication to make a modification of a parameter, and determine that an attribute of the modification is incompatible with a particular node in the blueprint 122. The guardrail enforcer 110 can enforce guardrails via a GUI as depicted in FIG. 17. As depicted in the GUI in FIG. 17, for each task, the guardrail enforcer 110 can indicate the input requirements for the data and the type of output provided. The input requirements can relate to attributes of the data set, such as the type of data (e.g., numeric) and the sparsity of the data (e.g., whether or not sparse data is supported or dense data is supported). The output of the node can refer to the type of output of the data from the node, such as numeric data type or whether the output data is sparse.

The guardrail enforcer 110 GUI can prevent, block, or generate an alert when a modification to a node (e.g., the rulefit regressor node depicted in FIG. 17) can negatively impact a prior node or a subsequent node in the blueprint 122. For example, there may be situations in which the output of the node may be incompatible with a next node, or situations in which the output of a prior node or previous node may not be compatible with the modified node. The guardrail enforcer 122 can provide a prompt or notification, as depicted in FIG. 17, as a guardrail to notify the user of the attributes of the input data and output data of the node being modified.

The guardrail enforcer 110 can obtain the required attribute or other guardrail or constraints information from the data repository 120. The data repository 120 can store the guardrail information for each type of task of computer-executable operations. For example, the guardrail information regarding required attributes for input data into a task or attributes of output of a task can be included in the model 126, the data transformation 128, or the post-processing 130. In some cases, the guardrail information can be stored in attributes 132 data structure, which can map to a corresponding model 126, data transformation 128, or post-processing 130.

The data processing system 102 can include a validator 112 designed, constructed and operational to validate or establish compatibility of a modified blueprint 122. The validator 112 can establish compatibility of the set of computer-executable operations responsive to the modification by the GUI or a custom-code provided by a user of the client device 140. The validator 112 can establish the compatibility of the set of computer-executable operations based on a comparison of an attribute of an output value of a first computer-executable operation of the set of computer-executable operations with an attribute of an input value of a second computer-executable operation, for example. The validator 112 can determine based on the comparison whether the attributes match or whether there is a mismatch. A match in attributes of an output of a node with attributes of an input of a subsequent node can refer to the data type being the same (e.g., numeric) or the sparsity being the same (e.g., sparsity supported by input or if sparsity is not supported by an input, then ensuring that the output of the prior node is not sparse). Other examples of matching of attributes can include the number of missing values supported, the shape of the data, or binary representation.

The validator 112 can be configured with a validation schema to establish compatibility of a modified task in the blueprint 122. The validator 112 can use the validation schema to define input and output requirements for a computer-executable operation in the blueprint 122. The data processing system 102 can use the validation to communicate the acceptable inputs for a computer-executable operation (e.g., a model) along with the expected output. The data processing system 102 can validate or verify the validation schema. The validation schema can be stored in data repository 120. The validation schema can be associated with each blueprint 122, or other data structure or file stored in the data repository 120.

The validation schema can include, for example:

typeSchema (optional): Top level dictionary that contains the input and output schema definitions: input_requirements (optional): Specifications that apply to the models input. The specifications provided as a list; output_requirements (optional): Specifications that define the expected output of the model. The specifications provided as a list.

The specification can contain the following fields:

field: which specification is being defined, one of data_types, sparse, number_of_columns;

condition: defines how the values in the value field are used;

value: A list or single value, depending upon the condition used.

The validation schema can include:

data_types allowed values:

condition: “EQUALS”, “IN”, “NOT EQUALS”, “NOT IN”;

value: “NUM”, “TXT”, “CAT”, “IMG”, “DATE”.

sparse (input) allowed values:

condition: “EQUALS”;

value: “FORBIDDEN”, “SUPPORTED”, “REQUIRED”.

sparse (output) allowed values:

condition: “EQUALS”;

value: “NEVER”, “DYNAMIC”, “ALWAYS”, “IDENTITY”.

number_of_columns allowed values:

condition: “EQUALS”, “IN”, “NOT EQUALS”, “NOT IN”, “GREATER_THAN”, “LESS_THAN”, “NOT_GREATER_THAN”, “NOT_LESS_THAN”;

value: Integer value>0.

An example of an input/output validation can be:

typeSchema:

input_requirements:
field: data_types

condition: EQUALS

value: NUM

output_requirements:

field: data_types

condition: EQUALS

value: NUM

An example of hyperparameter validation is as follows:

hyperparameters:

#select: Discrete set of unique values, similar to an enum. Default is optional, will use the first value if

#not provided.
name: numeric_imputer_strategy

type: select

values:
median
mean
most frequent
constant

#float: Floating point value, must provide a min and max. Default is optional, will use the min value if not provided
name: numeric_imputer_constant_fill

type: float

min: −100.0

max: 100.0

default: 0.0

#int: Integer value, must provide a min and max. Default is optional, will use the min value if not provided
name: numeric standardize with mean

type: int

min: 0

max: 1

default: 0

#string: Unicode string. Default is optional, will be an empty string if not provided.
name: categorical fill

type: string default: “unicode should work here”.

In some cases, the validator 112 can determine there is an incompatibility based on the validation check. The validator 112 can determine the custom computer-executable operation is incompatible with the set of computer-executable operations, for example based on the above validation schema. In response to determination of the incompatibility, the data processing system 102 can modify a computer-executable operation of the set of computer-executable operations. The data processing system 102 can automatically modify a computer-executable operation of the set of computer-executable operations to establish the compatibility. The data processing system 102 can provide a prompt via the graphical user interface indicating the automatic modification. To automatically modify the blueprint 122, the data processing system 102 can leverage, invoke, or otherwise utilize the validation schema, attributes 132 or other information stored in data repository 120. Thus, and in some cases, prior to the modification, the set of computer-executable operations automatically generated by the data processing system can lack a configuration to extract a feature from input data, and subsequent to modification and establishment of the compatibility, the set of computer-executable operations can be configured to extract the feature from the input data.

The data processing system 102 can include a blueprint constructor 114 designed, constructed and operational to construct the blueprint 122. The blueprint constructor 114 can construct the modified blueprint 122. The data processing system 102 (e.g., via the blueprint constructor 114) can construct, responsive to the modification, the set of computer-executable operations with the custom computer-executable operation. The blueprint constructor 114 can construct, responsive to establishment of the compatibility, the set of computer-executable operations for use with machine learning. Constructing the blueprint 122 can refer to or include connecting the nodes (e.g., tasks or computer-executable operations) with edges. Constructing the blueprint 122 can refer to or include generating a directed acyclic graph that represents the data flow from input to output via the blueprint 122. The data processing system 102 can store the constructed blueprint 122 in data repository 120. The data processing system 102 can store the constructed blueprint 122 as code or computer-executable operations.

The data processing system 102 can execute the constructed set of computer-executable operations to generate a model based on the data set via machine learning. The data processing system 102 can deploy the model to make predictions based on an input data stream different from the data set.

In some cases, the user can switch to an SDK mode in which the user can provide further custom modifications to the blueprint 122 that was modified with the task. The user can further modify parameters of tasks in the blueprint. For example, the data processing system 102 can receive the modification comprising at least one of a custom task generated via a software development kit, or a modification to a task of the plurality of tasks automatically generated by the data processing system for the blueprint. The data processing system 102 can generate, via the software development kit, a plurality of blueprints based at least in part on the modification. The data processing system 102 can present a visualization for the plurality of blueprints via the graphical user interface.

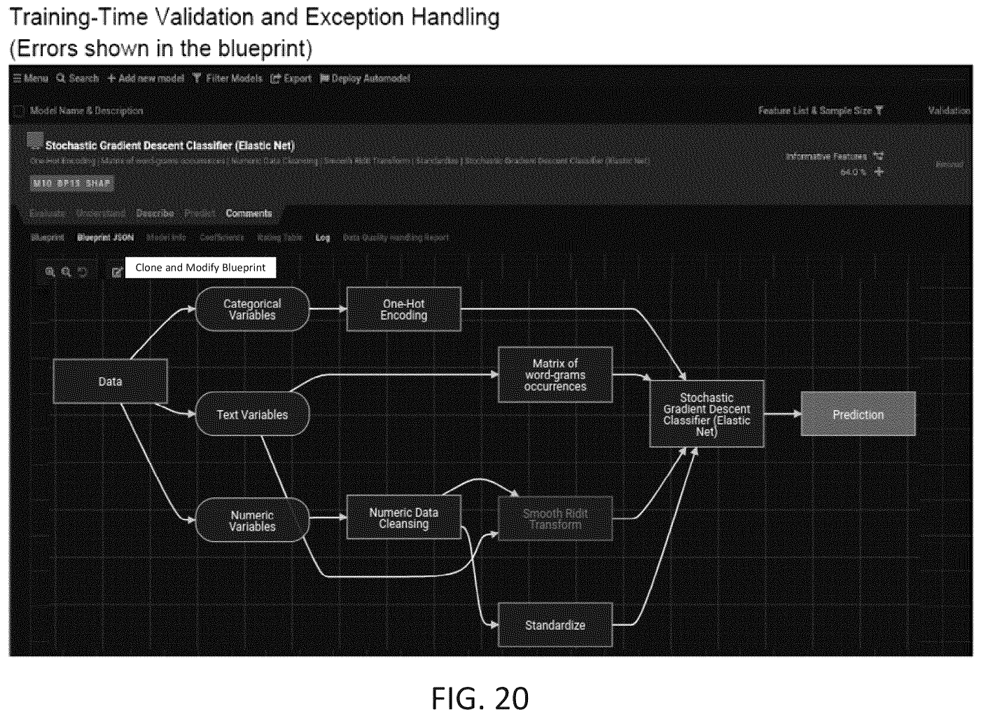

The data processing system 102 can include a visualizer 116 designed, constructed and operational to provide a visualization of the constructed blueprint 122. The visualization can include a directed graph, such as the directed graph presented via example GUI depicted in FIG. 7 or FIG. 20, for example.

The visualizer 116 can provide further insights associated with the constructed blueprint 122. The visualizer 116 can present insights associated with each data processing step in the blueprint 122. The visualizer 116 can provide visualization associated with tasks that are custom tasks as well as automatically generated tasks. Thus, the visualizer 116 can integrate customized tasks with automatically generated blueprints 122.

The visualizer 116 can provide, upon execution of the constructed set of computer-executable operations, via the graphical user interface, a first visual representation of data generated subsequent to execution of a first computer-executable operation of the set of computer-executable operations. The visualizer 116 can provide, via the graphical user interface, a second visual representation of data generated subsequent to execution of a second computer-executable operation of the set of computer-executable operations. The visualizer 116 can present, via the graphical user interface, the set of computer-executable operations as a directed acyclic graph.

The data processing system 102 can include a file-sharing component 118 designed, constructed and operational to share a blueprint 122. The data processing system 102 can share a customized blueprint 122. The data processing system 102 can share a modified blueprint 122 that was constructed with a custom task. The data processing system 102, upon modification and establishment of compatibility, can request permissions or authorization from the user to share the blueprint 122. In some cases, the user can secure the blueprint 122 to prevent sharing. In some cases, the user can authorize sharing to only certain individuals with permission. For example, the user can authorize or permit sharing of a custom blueprint 122 to users within a same organization or entity. The user can authorize the blueprint 122 to be shared with others associated with a same account identifier. Thus, the file-sharing component 118 can share at least a portion of the set of computer-executable operations with a second client device for inclusion in a second set of computer-executable operations established via the second client device. The data processing system 102 can provide the task for sharing via the automatic blueprint generator 106 or as part of a catalog 124 of tasks from which a second user can select a task with which to modify a blueprint 122 via modifier 108, for example.

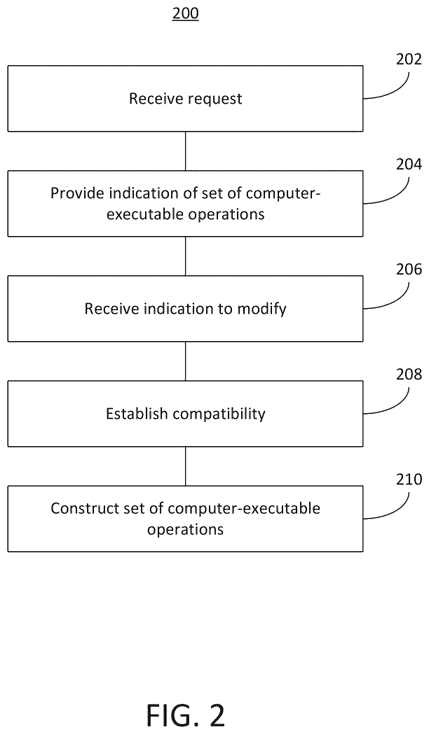

Referring to FIG. 2, a method of customizing an automated machine learning system is provided. The method 200 can be performed by one or more system or component depicted in FIG. 1 or FIG. 25, including, for example, a data processing system. In brief overview, the method 200 can include the data processing system receiving a request at ACT 202. The data processing system can provide an indication of a set of computer-executable operations at ACT 204. The data processing system can receive an indication to modify the set of computer-executable operations at ACT 206. The data processing system can establish compatibility at ACT 208. The data processing system can construct a set of computer-executable operations at ACT 210.

Still referring to FIG. 2, and in further detail, the method 200 can include the data processing system receiving a request at ACT 202. The data processing system can receive a request to automatically generate a blueprint. The request can be input by a user of a client device via a graphical user interface. The request can include or indicate a data set for which to generate the blueprint. The data set can be a set of data obtained, collected, or otherwise provided by a client device or user thereof. For example, the data set can refer to sensor data collected by sensors and stored in a data repository of the client device or in a cloud storage system.

At ACT 204, the data processing system can provide an indication of a set of computer-executable operations. The data processing system can provide, for display via a graphical user interface on the client device, an indication of a set of computer-executable operations generated automatically for machine learning on the data set by the data processing system responsive to the request. The data processing system can provide multiple different blueprints for display, or indications of the blueprints (e.g., names or other descriptive information of the blueprint).

At ACT 206, the data processing system can receive an indication to modify the set of computer-executable operations. A user can interact with a GUI to make a selection of a blueprint to use or modify for the machine learning project. The indication can include a new task, new edge connection, updating an attribute or parameter of a task, removing a task, re-ordering a task, or other modification. The indication can be a GUI drag-and-drop instruction, or uploading a code generated via an SDK.

At ACT 208, the data processing system can establish compatibility at ACT 208. The data processing system can establish compatibility using a validation schema, for example. The data processing system can update one or more aspects of the modified blueprint to establish compatibility. In some cases, the data processing system can provide a warning or alert and request the user to modify the blueprint to establish compatibility.

At ACT 210, the data processing system can construct a set of computer-executable operations. The data processing system can store the blueprint or otherwise execute or run the blueprint. The data processing system can generate executable code for the blueprint so the blueprint can be deployed for use in a real-time data processing computing environment.

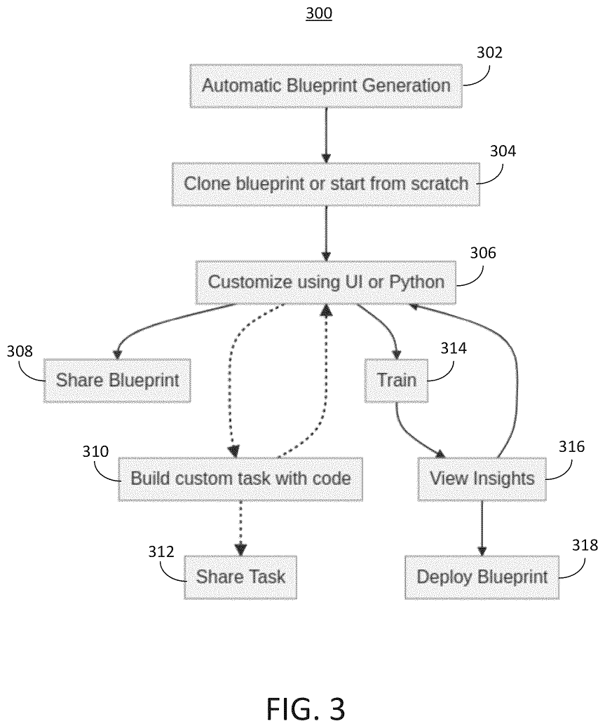

Referring now to FIG. 3, block diagram of an example method for customizing an automated machine learning system. The method 300 can be performed by one or more system or component depicted in FIG. 1 or FIG. 25, including, for example, a data processing system. With this method, the data processing system can provide a way to leverage the advantages of automated machine learning, in addition to automated data preparation, automated insights, automated deployment and automated monitoring, even for custom solutions. The data processing system can allow for the combination of custom solutions across an organization with one another, and with predefined tasks (offered by an automated machine learning solution). The data processing system can provide organizations with a personal growing ecosystem of custom and automated solutions to be combined and leveraged by even non-technical users, further democratizing their ability to leverage machine learning as an organization.

At ACT 302, the data processing system can perform automatic blueprint generation. The automated machine learning platform of the data processing system can generate blueprints based on the project data, the prediction target, appropriate partitioning, or any other up-front configurations specified by the user. The data processing system can perform automated data preparation, such as cleaning, incorporating time-series or other automatic feature generation, etc. The data processing system can perform data quality assessment to ensure that as much as possible has been communicated to the user about the dataset and what to expect or actions to take to ensure the highest quality models are obtained.

At ACT 304, the data processing system can clone a blueprint or start from scratch. Once all blueprints have been generated, a user can assess what has been presented, and choose to either build additional blueprints from scratch to be assessed alongside the other blueprints (with identical partitioning etc.) or modify the generated blueprints as desired. For example, a user can clone one of the automatically generated blueprints, and the make a modification. Or, in another example, the user can build a blueprint from scratch, either via a GUI or the SDK.

At ACT 306, the user can customize the blueprint using the GUI or an SDK or python code. These actions can be performed without using any code, and so highly accessible to those without coding experience. In some cases, the actions can be performed with code, and so can be programmatic in nature-allowing the user to generate an unbounded number of blueprints, either from scratch, or in the form of perturbations to generated blueprints. The actions can include removal, modification, substitution, or addition. The actions can be to:

i. comply with regulatory or organizational requirements

ii. incorporate in-house/existing organization-specific or domain-specific approaches to data transformation or prediction

iii. increase interpretability

iv. increase the speed of inference

v. obtain alternative or additional insights

vi. verify optimality and/or increase accuracy

vii. incorporate modeling approaches unavailable in the product, such as alternative open-source or competing approaches viii. generally explore the impact of using alternative tasks (either custom-built by the organization, or pre-built in the product) to those used in the blueprint

ix. otherwise perform general research surrounding the problem at-hand.

At ACT 314, the data processing system can train a model with the customized blueprint. Once modifications have been made to the desired blueprints, they can be trained and assessed. Technical problems may vary dramatically, so the user may allow automated configuration of the blueprints, which will integrate important logic and heuristics from the automated machine learning solution, to further improve upon their modified blueprints.

At ACT 308, the user can share the blueprint. At ACT 310, the user can build a custom task with the code and then share the task at ACT 312. At ACT 316, the data processing system can provide insights for presentation via a GUI. At ACT 318, the data processing system can deploy the blueprint. The user may decide to continue to iterate, based on any insights or assessments they made, this may come in the form of: a. Introducing new custom tasks via: i. writing new code ii. uploading code from their organization iii. finding and uploading open source code, for example.

Thus, the data processing system can share custom-built tasks with others and/or combined with automated machine learning tasks or other custom-built tasks without writing code to build transparent, interpretable, deployable and monitorable machine learning solutions. The data processing system can allow individuals across an organization to create tasks in different languages or with different dependencies and the data processing system can make them seamlessly work together.

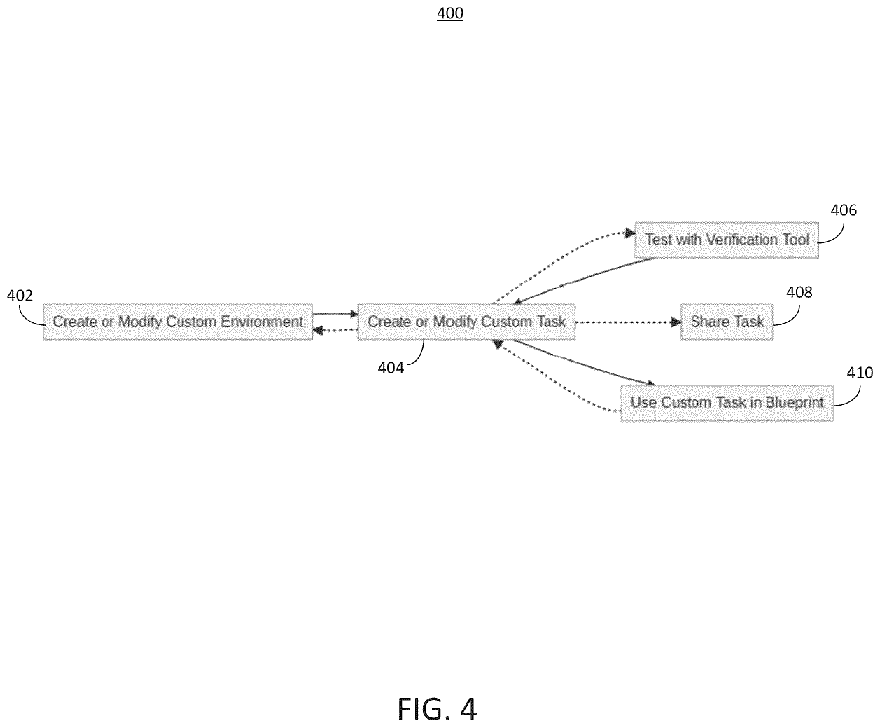

FIG. 4 depicts a block diagram of an example method for customizing an automated machine learning system. The method 300 can be performed by one or more system or component depicted in FIG. 1 or FIG. 25, including, for example, a data processing system. The method 400 can depict a process for custom task creation. At ACT 402, the data processing system can receive an indication to create or modify a custom environment, as depicted via example GUI in FIG. 5. At ACT 404, the user can create or modify a custom task, such as a data transformation, estimator, pre-processing, or post-processing, as depicted via example GUI in FIG. 6. The data processing system can receive an indication to modify an automatically generated blue print with a custom task, as depicted in example GUI in FIG. 7. When building or modifying a task, in order to ensure a short feedback loop, the user can use a locally downloadable tool which validates proper construction and proper production of output based on some or each input.

At ACT 406, the data processing system can test the modification or customization with the verification tool (e.g., a validator or validation schema). At ACT 408, the data processing system can share the customized task, in accordance with user permissions and authorization. At ACT 410, the data processing system can use the custom task in a blueprint. For example, the data processing system can integrate the custom task in the blueprint and establish compatibility of the blueprint with the custom task.

FIGS. 5-24 are example graphical user interfaces that facilitate customizing an automated machine learning system. The GUIs of FIGS. 5-24 can be provided by one or more system or component depicted in FIG. 1 or FIG. 25, including, for example, a data processing system.

The data processing system can provide, via the GUIS, for both code and the UI, all available tasks, including those created by a user, along with each of their valid parameters and their types, to the user. The process can include:

1. Create a Blueprint
a. Via Code
   i. Clone a blueprint and directly modify the blueprint construction code
   ii. Create a blueprint from scratch with blueprint construction code
b. Via UI
   i. Clone a blueprint (immediately opened in Editor)
   ii. Create an empty blueprint (immediately opened in Editor)

2. Modify a Blueprint
a. Via Code
   i. Directly edit the blueprint construction code to represent the desired blueprint
b. Via UI
   i. Add a new node (plus icon)
   ii. Remove a node (trash can icon)
   iii. Add a new connection (drag to create connection)
   iv. Remove a connection (trash can icon)
   v. Substitute a node
   vi. Modify the parameters of a node
      1. Automatically validate each parameter

3. Specification of Valid Construction
a. Each node provides information for what can be provided as input, and what can be expected as output (with no knowledge of actual data)
b. Each task provides documentation to ensure understanding of when and how to leverage the task and how to configure all parameters.

4. Save or Update the Blueprint
a. immediately provides validation feedback to the user
   i. Warnings—may fail or cause unintended behavior
   ii. Errors—expected or guaranteed to fail

5. Add Blueprint to a Project Repository of Blueprints
a. Automatically alter the configuration of the Blueprint to comply with the target project

6. Train Blueprint
a. Perform data-aware validation to ensure proper reporting of encountered errors
b. Observe where any failures may have occurred in the Blueprint and what the failure was.

FIG. 8 is an example of code-based modification of a GUI. As illustrated, the data processing system can receive code via an SDK. Code may be used for the implementation of custom user-written tasks. The data processing system can provide a UI which allows the construction of blueprints which can combine user-written tasks and predefined tasks together, in a simple, visual interface, usable by anyone in an organization. The data processing system can provides an easy-to-use code-based interface to support users in facilitating deep customization of our automated machine learning solution, by allowing for programmatic customization of generated blueprints or creation of entirely new ones. The data processing system can provide the implementation code for a blueprint responsive to a user request for any blueprint and modified, allowing a user to seamlessly move between code and the UI or collaboration with a UI-only user.

FIG. 9 depicts an example of UI based modification. The user can drag-and-drop nodes or edges. The user can select a ‘+’ icon to add a node or edge.

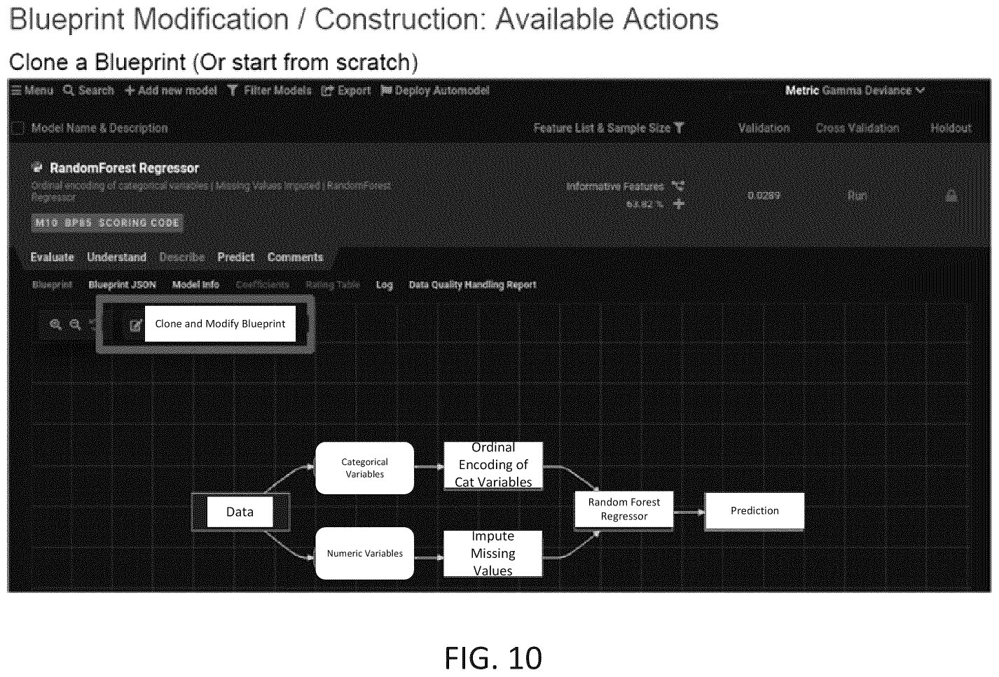

FIG. 10 depicts an example of actions that are available for blueprint modification or construction. The actions can include cloning the blueprint or modifying an automatically generated blueprint.

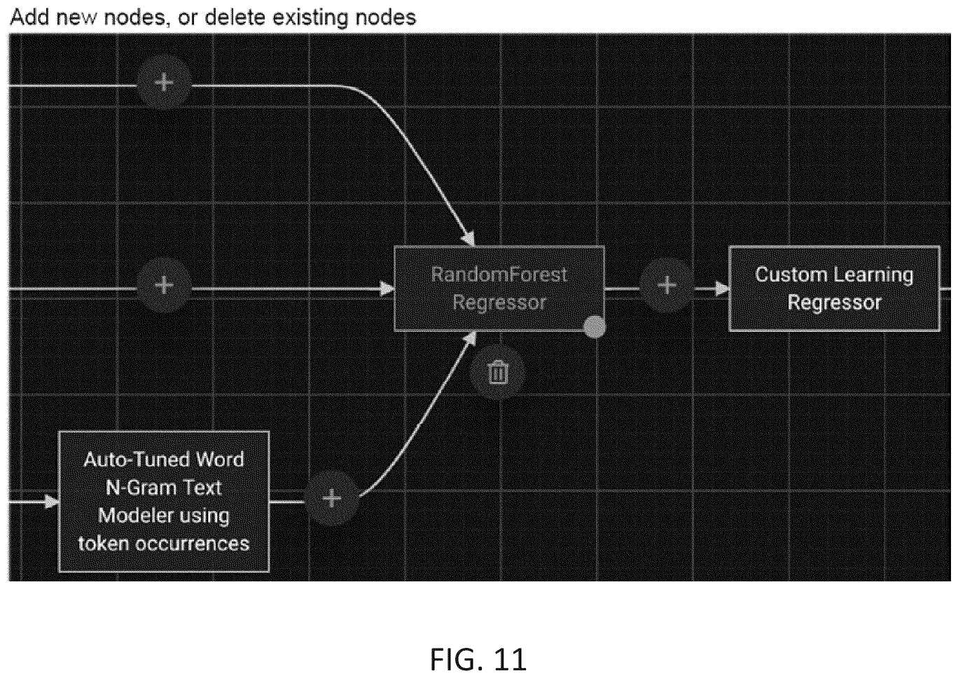

FIG. 11 depicts an example of GUI-based interactions for modifying a blueprint. A user can add new nodes via the ‘+’ icon, or delete nodes via the trash can icon, for example.

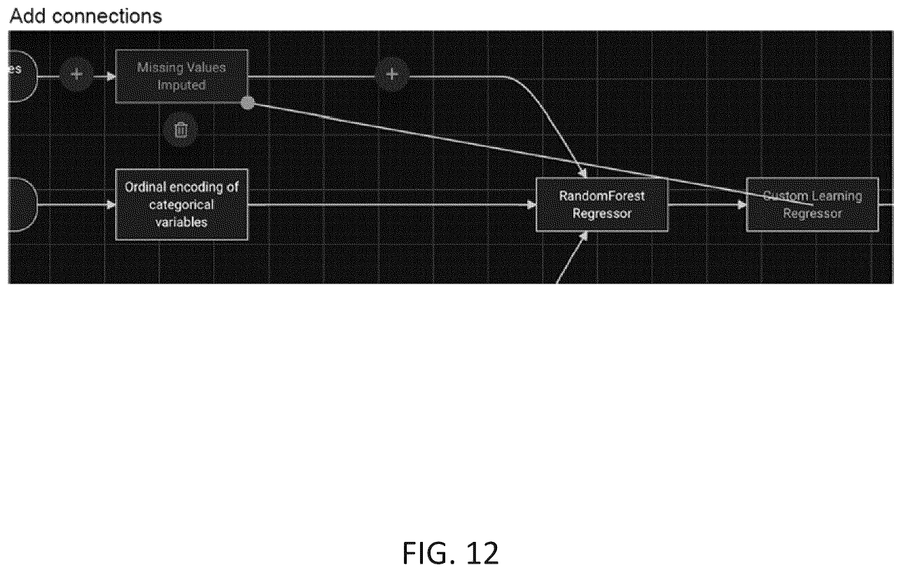

FIG. 12 depicts an example of GUI-based interactions for adding connections or edges between nodes. The user can drag-and-drop new connections.

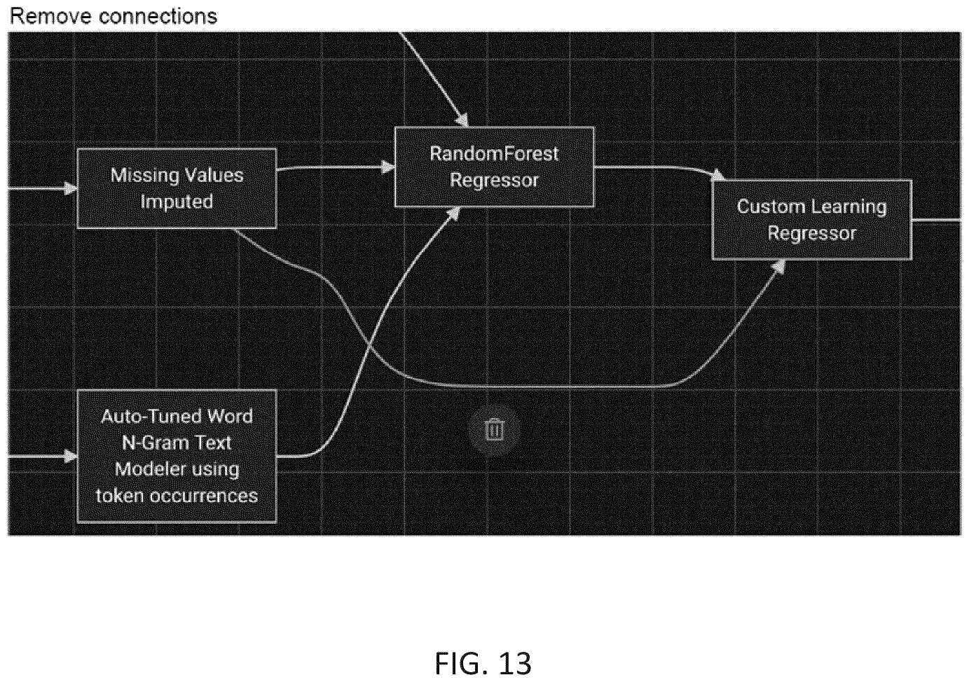

FIG. 13 depicts an example of GUI-based interactions for removing a connection, such as via the trash can icon.

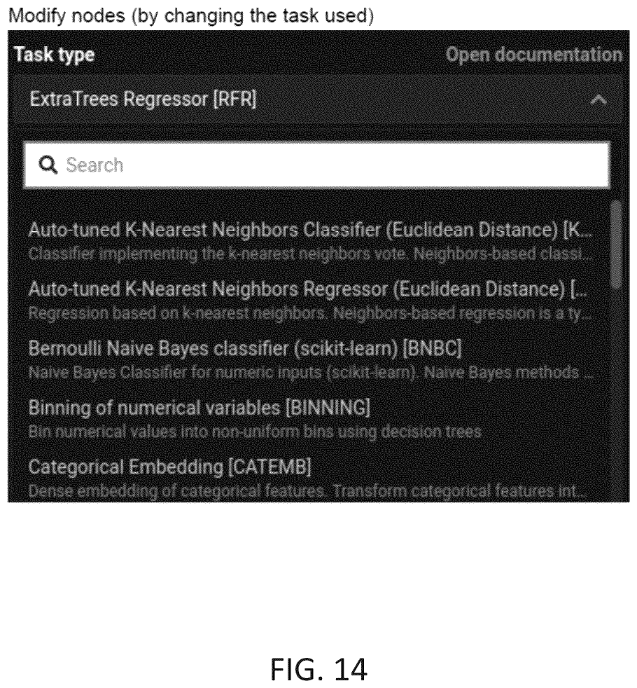

FIG. 14 depicts an example GUI for searching for a new task to add or a new node to add or modify. The GUI can depicts a catalog of tasks and the user can search through the catalog of tasks. The GUI can include a dropdown menu listing tasks.

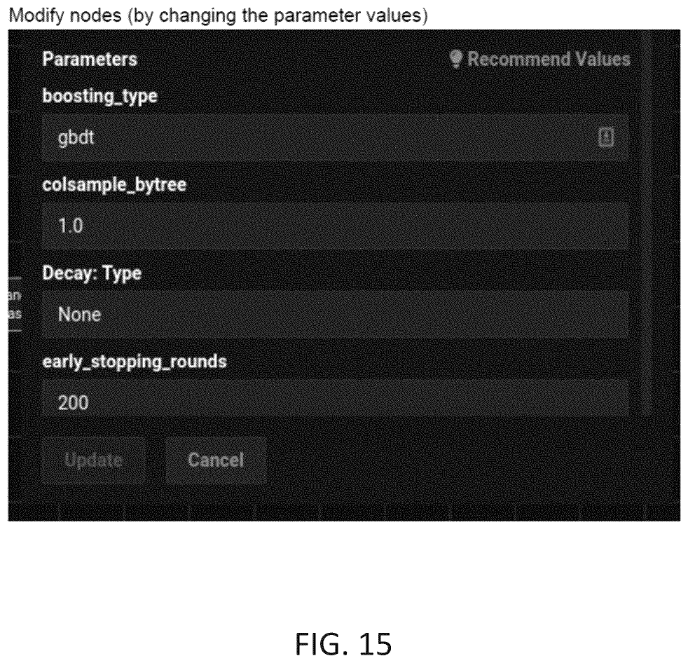

FIG. 15 depicts an example GUI for modifying a node (e.g., a computer-executable operation or task). The GUI can allow for modification of parameters associated with the task. The task can be a data transformation, pre-processing step, post-processing, or model.

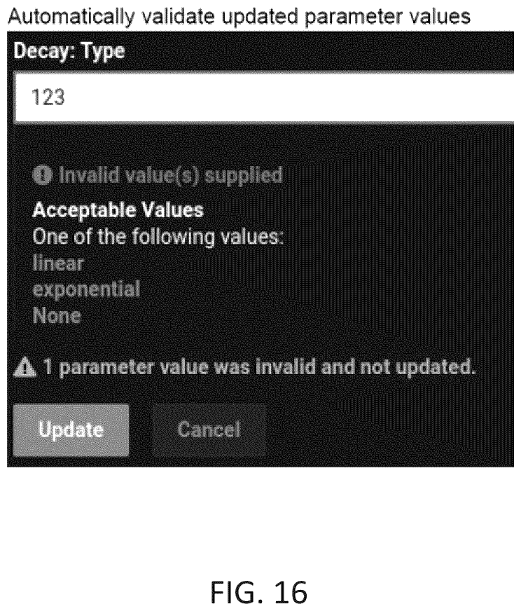

FIG. 16 depicts an example GUI for validating or establishing compatibility of an updated parameter. The GUI of FIG. 16 can be presented by a guardrail enforcer of data processing system. The GUI can indicate a guardrail established for the task or parameter. For example, the data processing system can indicate that a decay type is not valid because it is not an acceptable type, per the attributes for the decay type. For example, the acceptable values may be linear, exponential or none. The user can update the input value via the GUI of FIG. 16 to prevent or avoid an error in the task or blueprint.

FIG. 17 depicts an example GUI for guardrails and validation associated with modifying a blueprint or constructing a blueprint. Each task can indicate an attribute associated with an input to the task, and an output of the task.

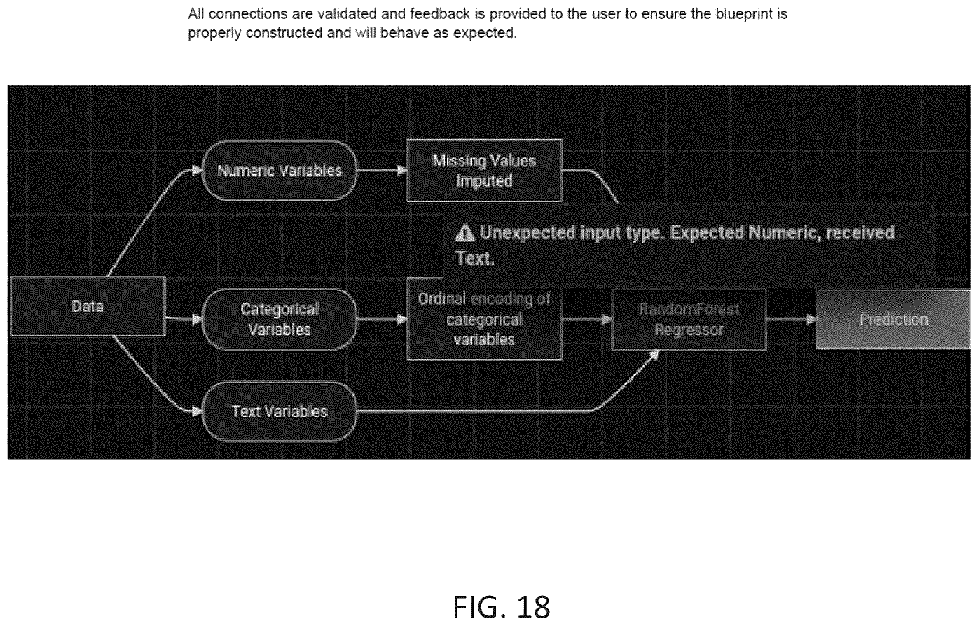

FIG. 18 depicts an example GUI for in which connections are validated and feedback is visually provided to the user to ensure that the blueprint is properly constructed and can behave as expected. For example, the data processing system can indicate, via the GUI, if there is an unexpected input type, as well as the expected types of input.

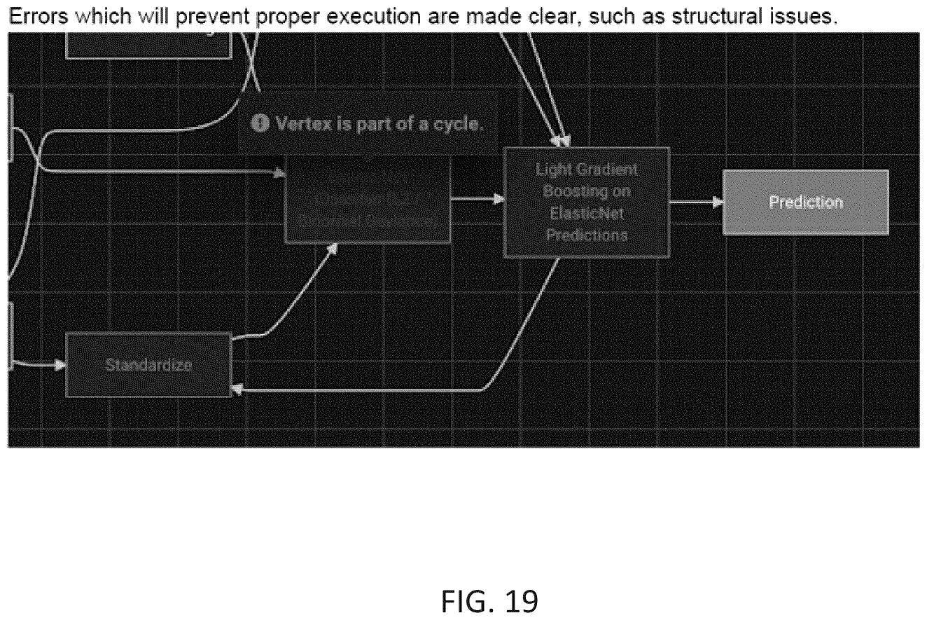

FIG. 19 depicts an example GUI in which the data processing system can indicate errors that can prevent proper execution of the modified blueprint. Errors can be structural issues, for example.

FIG. 20 depicts an example GUI in which the data processing system can provide a visualization of training time validation and exception handling. The data processing system can indicate whether a particular node, or task in the blueprint has an error or exception.

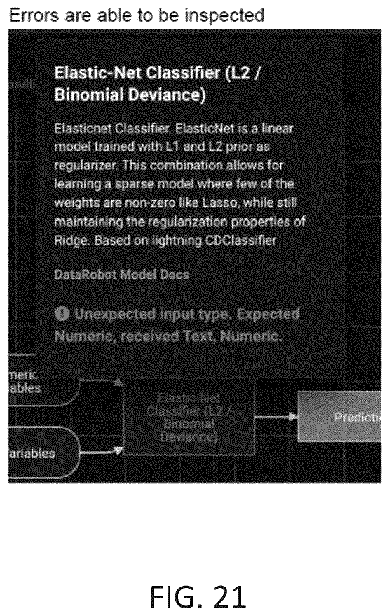

FIG. 21 depicts an example GUI in which the data processing system can indicate the error that was detected during training-time or validation. The data processing system can provide additional information associated with the cause of the error via a pop-up window or prompt.

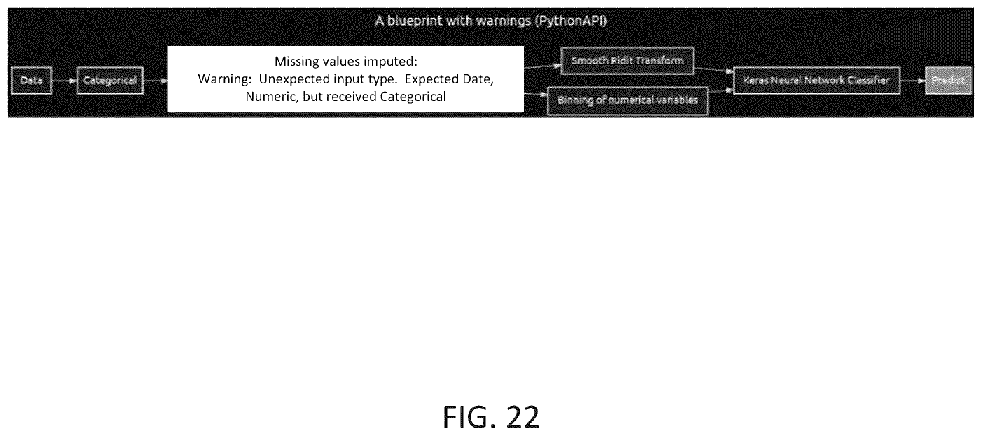

FIG. 22 depicts an example GUI for validating a blueprint. The data processing system, during validation, can determine there is an error with a task. For example, the task can be to impute missing values. The data processing system detect that there is an error associated with the type of data. For example, the data processing system can expect an input type of numeric or dates, but the data processing system may have received categorical input. The data processing system can detect this mismatch between the expected data type for this pre-processing task and the actual input, and generate this visual indication.

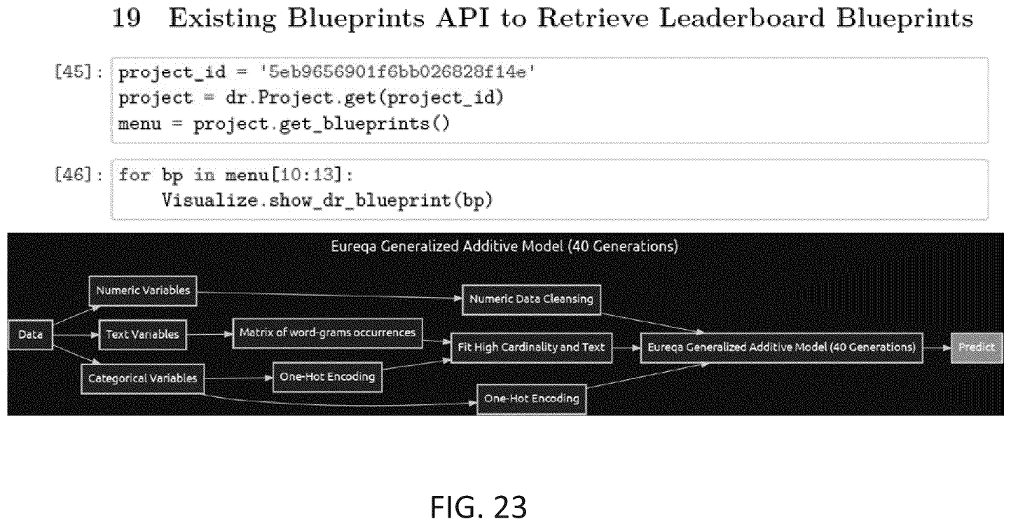

FIG. 23 depicts an example GUI for obtaining or retrieving an existing blueprint. The data processing system can provide an API to retrieve automatically generated blueprints.

FIG. 24 depicts an example GUI in which a user can clone a blueprint. The user can select and retrieve an automatically generated blueprint, or a shared blueprint. The user can use an SDK or API to make modifications to the blueprint, such as to parameters of the blueprint, and further generated multiple new blueprints. Thus, the user can seamlessly switch between GUI and SDK based modifications to the blueprints.

Thus, systems and methods of this technical solution can provide for step-by-step view or visualization of how the user's data changes as each transformation or model is applied to their data. This can improve transparency as the user can clearly see what impact the task has on the data after each step. Such as, how effective a certain standardization task is, or how well a clustering task clusters the data, etc. The feedback supplied directly informs the user on how to proceed and what types of changes can be considered.

The systems and methods of this technical solution can provide auto-complete during blueprint construction. The technology can automatically suggest tasks to use when the blueprint is being built in order to provide the best experience possible for the user building the blueprint to be used for modeling.

The technology can provide custom metric to allow users to supply a custom metric which all models are assessed with in order to put the benchmark on their terms and understand and demonstrate various blueprint performance based on KPIs and metrics familiar to their organization.

FIG. 25 is an example computer system that can be used in implementing technology described herein, including, for example, the system depicted in FIG. 1, the methods depicted in FIGS. 2-4, and the graphical user interfaces depicted in FIGS. 5-24. FIG. 25 is a block diagram of an example computer system 2500 that may be used in implementing the technology described in this disclosure. General-purpose computers, network appliances, mobile devices, or other electronic systems may also include at least portions of the system 2500. The system 2500 includes a processor 2510, a memory 2520, a storage device 2530, and an input/output device 2540. Each of the components 2510, 2520, 2530, and 2540 may be interconnected, for example, using a system bus 2550. The processor 2510 is capable of processing instructions for execution within the system 2500. In some implementations, the processor 2510 is a single-threaded processor. In some implementations, the processor 2510 is a multi-threaded processor. The processor 2510 is capable of processing instructions stored in the memory 2520 or on the storage device 2530.

The memory 2520 stores information within the system 2500. In some implementations, the memory 2520 is a non-transitory computer-readable medium. In some implementations, the memory 2520 is a volatile memory unit. In some implementations, the memory 2520 is a non-volatile memory unit.

The storage device 2530 is capable of providing mass storage for the system 2500. In some implementations, the storage device 2530 is a non-transitory computer-readable medium. In various different implementations, the storage device 2530 may include, for example, a hard disk device, an optical disk device, a solid-date drive, a flash drive, or some other large capacity storage device. For example, the storage device may store long-term data (e.g., database data, file system data, etc.). The input/output device 2540 provides input/output operations for the system 2500. In some implementations, the input/output device 2540 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 2560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 2530 may be implemented in a distributed way over a network, for example as a server farm or a set of widely distributed servers, or may be implemented in a single computing device.

Although an example processing system has been described in FIG. 25, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system, comprising:
a data processing system comprising one or more processors, coupled with memory, to:
receive, from a client device via a network, a request to establish computer-executable operations for use with machine learning on a data set;
provide, for display via a graphical user interface on the client device, an indication of a set of computer-executable operations generated automatically for machine learning on the data set by the data processing system responsive to the request;
receive, from the client device via the graphical user interface, an indication to modify the set of computer-executable operations;
establish compatibility of the set of computer-executable operations responsive to the modification; and
construct, responsive to establishment of the compatibility, the set of computer-executable operations for use with machine learning.

2. The system of claim 1, wherein the data processing system is further configured to:
select a plurality of computer-executable operations that map to an attribute of the data set;
present, via the graphical user interface, an indication of the plurality of computer-executable operations; and
receive, from the client device, an instruction to replace at least one of the plurality of computer-executable operations with at least one of a computer-executable operation at least partially coded by a user via a software development kit or selected by the user via a catalog of computer-executable operations.

3. The system of claim 1, wherein the data processing system is further configured to:
receive, from the client device, an indication to add a custom computer-executable operation in the set of computer-executable operations, the custom computer-executable operation comprising code generated by a user via a software development kit and uploaded to the data processing system;
determine the custom computer-executable operation is incompatible with the set of computer-executable operations;
modify, responsive to the determination of incompatibility, a computer-executable operation of the set of computer-executable operations; and
construct, responsive to the modification, the set of computer-executable operations with the custom computer-executable operation.

4. The system of claim 1, wherein the data processing system is further configured to:
establish the compatibility of the set of computer-executable operations based on a comparison of an attribute of an output value of a first computer-executable operation of the set of computer-executable operations with an attribute of an input value of a second computer-executable operation.

5. The system of claim 4, wherein the attribute corresponds to at least one of a data type, a data sparsity, a binary representation of data, a shape of data, or missing values.

6. The system of claim 1, wherein the data processing system is further configured to:
automatically modify a computer-executable operation of the set of computer-executable operations to establish the compatibility.

7. The system of claim 6, wherein the data processing system is further configured to:
provide a prompt via the graphical user interface indicating the automatic modification.

8. The system of claim 1, wherein the data processing system is further configured to:
execute the constructed set of computer-executable operations to generate a model based on the data set via machine learning; and
deploy the model to make predictions based on an input data stream different from the data set.

9. The system of claim 1, wherein prior to the modification, the set of computer-executable operations automatically generated by the data processing system lacks a configuration to extract a feature from input data, and subsequent to modification and establishment of the compatibility, the set of computer-executable operations is configured to extract the feature from the input data.

10. The system of claim 1, wherein the data processing system is further configured to:
provide, upon execution of the constructed set of computer-executable operations, via the graphical user interface, a first visual representation of data generated subsequent to execution of a first computer-executable operation of the set of computer-executable operations; and
provide, via the graphical user interface, a second visual representation of data generated subsequent to execution of a second computer-executable operation of the set of computer-executable operations.

11. The system of claim 1, wherein the data processing system is further configured to:
present, via the graphical user interface, the set of computer-executable operations as a directed acyclic graph.

12. The system of claim 1, wherein the set of computer-executable operations comprise at least one of a data transform or a prediction.

13. The system of claim 12, wherein the data processing system is further configured to:
share at least a portion of the set of computer-executable operations with a second client device for inclusion in a second set of computer-executable operations established via the second client device.

14. A method, comprising:
receiving, by a data processing system comprising one or more processors coupled with memory, from a client device via a network, a request to establish computer-executable operations for use with machine learning on a data set;
providing, by the data processing system for display via a graphical user interface on the client device, an indication of a set of computer-executable operations generated automatically for machine learning on the data set by the data processing system responsive to the request;
receiving, by the data processing system from the client device via the graphical user interface, an indication to modify the set of computer-executable operations;
establishing, by the data processing system, compatibility of each computer-executable operation of the set of computer-executable operations responsive to the modification; and
constructing, by the data processing system responsive to establishment of the compatibility, the set of computer-executable operations for use with machine learning.

15. The method of claim 14, comprising:
selecting, by the data processing system, a plurality of computer-executable operations that map to an attribute of the data set;
presenting, by the data processing system via the graphical user interface, an indication of the plurality of computer-executable operations; and
receiving, by the data processing system from the client device, an instruction to replace at least one of the plurality of computer-executable operations with a computer-executable operation at least partially coded by a user.

16. The method of claim 14, comprising:
receiving, by the data processing system from the client device, an indication to add a custom computer-executable operation in the set of computer-executable operations, the custom computer-executable operation comprising code generated by a user and uploaded to the data processing system;
determining, by the data processing system, the custom computer-executable operation is incompatible with the set of computer-executable operations;
modifying, by the data processing system responsive to the determination of incompatibility, a computer-executable operation of the set of computer-executable operations; and
constructing, by the data processing system responsive to the modification, the set of computer-executable operations with the custom computer-executable operation.

17. The method of claim 14, comprising:
establishing, by the data processing system, the compatibility of the set of computer-executable operations based on: i) a comparison of an attribute of an output value of a first computer-executable operation of the set of computer-executable operations with an attribute of an input value of a second computer-executable operation.

18. The method of claim 14, wherein the attribute corresponds to at least one of a data type, a data sparsity, a binary representation of data, a shape of data, or missing values.

19. A system, comprising:
a data processing system comprising one or more processors, coupled to memory, to:
receive, from a client device via a network, a request to establish a blueprint comprising a plurality of tasks for use with machine learning;
generate, automatically by the data processing system, the blueprint with the plurality of tasks;
provide, for display via a graphical user interface on the client device, an indication of the plurality of tasks of the blueprint automatically generated by the data processing system responsive to the request from the client device;
receive, from the client device via the graphical user interface, a modification to the blueprint;
establish compatibility of each task of the blueprint responsive to the modification; and
construct, responsive to establishment of the compatibility, the blueprint for use with machine learning.

20. The system of claim 19, wherein the data processing system is further configured to:
receive the modification comprising at least one of a custom task generated via a software development kit, or a modification to a task of the plurality of tasks automatically generated by the data processing system for the blueprint;
generate, via the software development kit, a plurality of blueprints based at least in part on the modification; and
present a visualization for the plurality of blueprints via the graphical user interface.
